(19) United States
(12) Patent Application Publication
(10) Pub. No.: US 2003/0046177 A1
(43) Pub. Date: Mar. 6, 2003

(54) 3-dimensional imaging service

(76) Inventors: Graham Winchester, Roanoke, TX (US); Robert Lange, Arlington, TX (US)

Correspondence Address: D. Scott Hemingway, Law Offices of D. Scott Hemingway, Preston Commons West, Suite 800, 8117 Preston Rd., Dallas, TX, 75225, US

(21) Appl. No.: 09/946,423

(22) Filed: Sep. 5, 2001

(51) Int. Cl. G06F 17/60

(52) U.S. Cl. 705/26

(57) ABSTRACT

The present invention sets forth a method for capturing a 3-dimensional data set of an object furnished by a consumer and then producing an art object from the data set using 3-dimensional imaging technology. A consumer enters a studio with an object to replicate. The studio captures a 3-dimensional image or data set of the object. A 3-dimensional imaging machine is then used to replicate the data set as an art object. The object is then delivered to the consumer.

### TECHNICAL FIELD OF THE INVENTION

A method and process for capturing 3-dimensional images and producing a sculpture in conjunction with its business method and operations.

### BACKGROUND OF THE INVENTION

Affordable and economically feasible custom 3-dimensional art work (e.g. sculptures, bas-reliefs, busts, etc.) of persons or things are not available to the public. Producing this art work is time consuming and demands an artist of considerable skill. An artist attempting to make a sculpture of a person can take days or even weeks to produce a 3-dimensional art work of a person. To make an exact duplication, a mold of a person's face can be taken to make a cast. However, taking a molding of a person's face to make in a cast is uncomfortable for the subject and impossible if the consumer wants a 3-dimensional art work done of the family pet. Artists can essentially produce a 3-dimensional likeness, but this resemblance is limited to approximations of physical appearance. Rather than being an exact replication, the traditional artist lacking a mold of the subject is limited to capturing a close likeness. For the average consumer, a traditional molding comes at a prohibitive expense.

Current technologies for capturing 3-dimensional images are limited and very expensive to use. The present invention solves a number of these problems. In the invention, precise 3-dimensional data sets covering multiple views of an object are captured in digital format and used to precisely replicate an object on a 3-dimensional imaging machine in greater precision than an artist can at much lower cost. This 3-dimensional data is processed and converted into file format for use on a 3-dimensional imaging machine. The 3-dimensional imaging machine can use this data to replicate a 3-dimensional image in an affordable and economical manner.

### SUMMARY OF THE INVENTION

The invention delivers an innovative product to the consumer in a unique manner. The basic goal of the present invention is to deliver, at relative low cost and shorter time frame, a sculpture, bas-relief, or similar art object. Using modern digital photography techniques and 3-dimensional imaging machines, sculptures, bas-reliefs, or similar art works can be produced faster and cheaper compared to more traditional and conventional methods. In the invention, a number of business locations or studios utilize a remote manufacturing facility containing one or more 3-dimensional imaging machines to replicate 3-dimensional data files into art objects. Each studio has a 3-dimensional camera setup with an associated image-processing computer.

A consumer will enter the studio with an object that he wishes to have replicated as an art object. This object can be an animate or inanimate object such as a person, pet, jewelry or similar object. The customer pays a fee, either cash or credit. Employees at the business capture an image of the object, which includes data sets covering the x, y, and z coordinates. The digital data of the object is processed into a format compatible with 3-dimensional imaging machines located at a separate manufacturing facility. The data is transmitted to the manufacturing facility. Transmission can be by dedicated land line, the Internet, local area network (LAN), mail or courier service conveying a data storage medium. An art object is then built using the data on a 3-dimensional imaging machine. The finished art object is then sent to the consumer.

### BRIEF DESCRIPTION OF THE DRAWINGS

The objects and features of the invention will become more readily understood from the following detailed description and appended claims when read in conjunction with the accompanying drawings in which like numerals represent like elements and in which:

FIG. 1 shows a basic configuration of a 3-dimensional digital camera system;

FIG. 2 is an alternative embodiment for a 3-dimensional digital camera system using a fan beam of light;

FIG. 3 is an alternative embodiment for a camera system using a turntable;

FIG. 4 is an alternative embodiment using a fan beam and a turntable;

FIG. 5 shows an alternative embodiment for capturing a multiple view 3-dimensional image set using three cameras;

FIG. 6 is another alternative embodiment for capturing a multiple view 3-dimensional image set using three cameras;

FIG. 7 is an embodiment for capturing a 3-dimensional data image using two digital cameras;

FIG. 8 is an alternative embodiment for capturing a multiple view 3-dimensional image using six digital cameras;

FIG. 9 is an embodiment for capturing a 3-dimensional data set using a laser camera or scanner;

FIG. 10 is an embodiment for capturing a multiple view 3-dimensional data set using three laser cameras or scanners;

FIG. 11 is an embodiment for a panning 3-dimensional camera system;

FIG. 12 is an embodiment for a 3-dimensional imaging machine using a UV laser and UV sensitive resin;

FIG. 13 is an alternative embodiment for a 3-dimensional imaging machine using two intersecting UV laser beams and UV sensitive resin;

FIG. 14 is another alternative embodiment for a 3-dimensional imaging machine using two UV laser beams and UV sensitive resin;

FIG. 15 is an embodiment for a 3-dimensional imaging machine using a laser to remove material from a block of material;

FIG. 16 is an alternative embodiment for a 3-dimensional imaging machine using two intersecting laser beams to remove material from a block;

FIG. 17 is another alternative embodiment for a 3-dimensional imaging machine using two lasers to remove material;

FIG. 18 is another alternative embodiment for a 3-dimensional imaging machine using a jointed arm and a cutting head to remove material;

FIG. 19 is an alternative embodiment using two jointed arms and cutting heads to remove material;

FIG. 20 is another embodiment using a laser beam to remove material and manipulate arms grasping a block of material;

FIG. 21 is another alternative embodiment using two intersecting lasers and manipulating arms to remove material from a block of material;

FIG. 22 is another embodiment using two lasers that do not intersect to remove material from a block of material;

FIG. 23 is an example of a 3-dimensional imaging machine that removes material from a block of material using a jointed arm with a cutting head and manipulating arms;

FIG. 24 is an embodiment for a 3-dimensional imaging machine using fused deposition modeling;

FIG. 25 is another embodiment for fused deposition modeling in which a UV light is used to bond the layers;

FIG. 26 is another embodiment for a fused deposition modeling 3-dimensional imaging machine with a curing source;

FIG. 27 is an alternative embodiment for fused deposition modeling where a laser is used to fuse layers together;

FIG. 28 shows a 3-dimensional imaging machine that uses selective laser sintering to bind the layers together;

FIG. 29 is an embodiment for a 3-dimensional imaging machine using an electrostatic sensitive substrate with a binder to build the layers;

FIG. 30 is an embodiment for a 3-dimensional imaging machine that lays down a pattern corresponding to the layer being replicated over a protective window and is then cured using UV light sources;

FIG. 31 is another possible embodiment for a 3-dimensional imaging machine using an electrostatic sensitive resin that becomes sensitive to UV light in the presence of an electric charge;

FIG. 32 is an example of a 3-dimensional imaging machine using laminated object modeling;

FIG. 33 is an embodiment of the invention with a camera system in a studio connected by the Internet and two communication computers to a manufacturing facility;

FIG. 34 is an alternative embodiment where the studio is connected directly to the Internet;

FIG. 35 is an alternative embodiment where the manufacturing facility MF and the studio are connected together through the Internet without a communication computer;

FIG. 36 shows an embodiment where there is a dedicated line or telephone line connecting the studio and the manufacturing facility;

FIG. 37 is an embodiment where a data transfer device is used to transmit data between the studio and manufacturing facility;

FIG. 38 is an embodiment of the invention where manufacturing and capturing 3-dimensional imaging takes place in the same facility; and

FIG. 39 shows the steps of the invention.

### DETAILED DESCRIPTION OF THE PREFERRED EMBODIMENTS

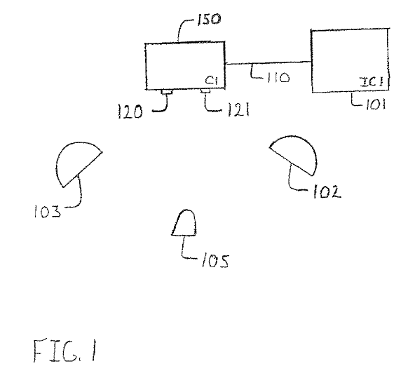

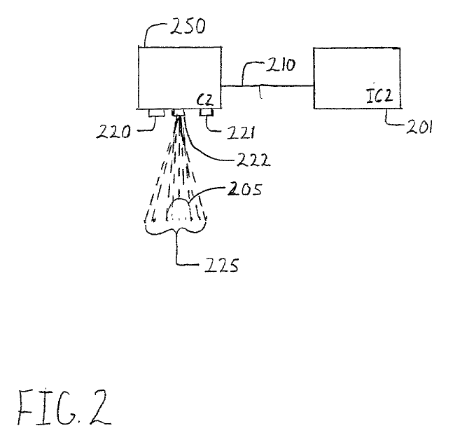

As shown in FIG. 1, the present invention uses two lenses from different viewpoints and digital camera technology, highly accurate 3-dimensional data images are taken at a first location. FIG. 1 shows a 3-dimensional digital camera C1 150, with two lenses 120 and 121, connected by cable 110 to an image-processing computer IC1 101. There are two light sources, 102 and 103, and an object 105. The 3-dimensional camera C1 150 uses the two lenses, 120 and 121, to capture two images from a slightly different viewpoint of the same object 105. The 3-dimensional camera C1 150 transmits image data by cable 110 to an image-processing computer IC1 101, which uses software to integrate and process the two images from lenses 120 and 121.

Although the imaging data from the two lenses 120 and 121 can be processed to provide a data image with 3-dimensional appearance, the data set necessary to construct an accurate 3-dimensional reproduction requires precise 3-dimensional data in the x, y, and z axis. Data for the x and y axis coordinates can be easily derived from the basic visual image.

To gather the necessary three-dimensional surface profile information, data is extracted from groups of pixels representing surface features. Smooth surfaces can make capture of the necessary data difficult. Although the light sources 102 and 103 provide illumination, a secondary use is to aid in obtaining range data. One method of using light sources 102 and 103 to determine range is to pulse the light source (e.g. a flash) and measure the time delay and differential of the received light. Another method is to measure the relative phase of modulation between transmitted and received light from each of the respective light sources 102 and 103. Another method is to form one or more light strips on the object's surface and determine range by triangulation measuring the position of the light strips in relation to the various optical sensors in the camera.

Although these methods of range determination will work with a single light source, it is contemplated that data capture and computer processing and integration from two light sources 102 and 103 will provide more accurate range measurements. Moreover, additional range determination technique may take into account differential triangulation data using two different light sources with different frequencies. Other embodiments using more than two light sources or a single light source and multiple frequencies for range-data capture are also possible.

As the 3-dimensional camera C1 150 captures image data, the 3-dimensional camera C1 150 converts the data into digital format, which is transferred to the image-processing computer IC1 101 over cable 110. Alternatively, the raw data can be transmitted to the image-processing computer IC1 101, which can convert the data into digital format.

After the image-processing computer IC1 101 receives the digital data from the 3-dimensional camera C1 150, the data is processed by program algorithms to produce a 3-dimensional data set. During the image processing, the data can be further manipulated to enlarge or reduce the size of the 3-dimensional image, crop the view of the data, eliminate unwanted visual aspects, or enhance desired visual aspects. This integrated processed data from the two lenses 120 and 121 is then converted into a data file compatible for use by a 3-dimensional imaging machine. Once the data set is finalized for use by a 3-dimensional imaging machine, it can be stored on the image-processing computer IC1 101, copied to a compact disc, or transmitted over a communication link.

FIG. 2 is another embodiment using a 3-dimensional digital camera with a fan beam light passed through a linear variable wavelength filter to accurately obtain range data. FIG. 2 shows a 3-dimensional digital camera C2 250 with two lenses 220 and 221 connected to an image-processing computer IC2 201 by cable 210. The camera C2 250 also has a beam emitter 222 that emits a fan beam of light 225 toward object 205. In this embodiment, the 3-dimensional camera C2 250 has two lenses 220 and 221 that capture visual data of an object 205. An image-processing computer IC2 201 receives data over cable 210, which the image-processing computer IC2 201 can process and manipulate. The 3-dimensional camera C2 250 also has a light emitter 223, which emits a fan beam 225 of light of varying wavelengths to illuminate the object 205. The pixels of the image sensors of the 3-dimensional camera C2 250 utilize triangular ranging to derive range data for the data elements of the captured image.

As the 3-dimensional camera C2 250 captures image data, the data from the two lenses 220 and 221 is converted to a digital format for output through cable 210 to the image-processing computer IC2 201. The image-processing computer IC2 201 receives the digital data from the 3-dimensional digital camera C2 250. The data is processed by program algorithms to produce a 3-dimensional data set from the two lenses 220 and 221. This integrated, processed data is further processed and manipulated to change the size, crop the view, eliminate unwanted visual aspects, or enhance desired visual aspects. Once the data set is finalized, the image-processing computer IC2 201 converts the data into a compatible format for use by a 3-dimensional imaging machine. The data can then be stored on the computer IC2 201, copied to a compact disc, or transmitted over a communications link.

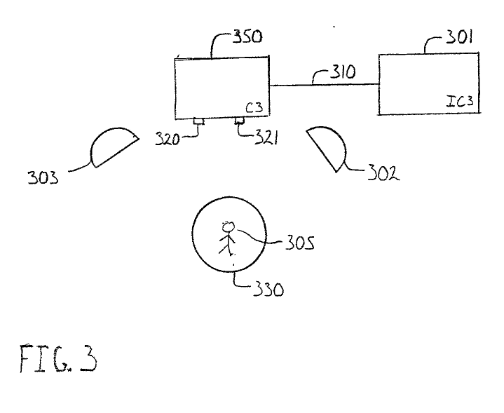

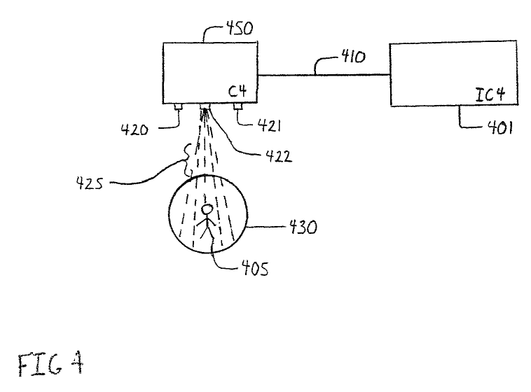

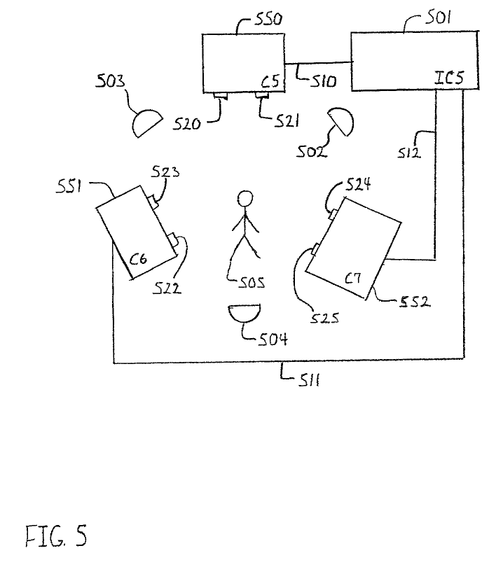

FIGS. 3 and 4 are other embodiments that can be used to capture a 3-dimensional data set covering multiple views of an object using a turntable. FIG. 3 shows a 3-dimensional digital camera C3 350 with two lenses 320 and 321 connected by a cable 310 to an image-processing computer IC3 301, two light sources 302 and 303, and an object 305, which rests on a turntable 330. The two light sources 302 and 303 provide illumination and range data reference during image capture of object 305. Object 305 is placed on the turntable 330, which rotates in an optimum fashion to facilitate capturing 3-dimensional data for every side of object 305. This rotation of turntable 330 may be continuous at a constant rate or intermittent as the 3-dimensional digital camera C3 350 captures 3-dimensional digital images of object 305.

As the 3-dimensional digital camera C3 350 captures images of object 305, digital data is transmitted over cable 310 to the image-processing computer IC3 301. After the image-processing computer IC3 301 receives the digital data from the 3-dimensional camera C3 350, the data is processed by program algorithms to produce a 3-dimensional data set. This integrated data from the multiple views of the two lenses 320 and 321 is further processed and converted into a data file compatible for use by a 3-dimensional imaging machine. During the image processing, the data can be further manipulated by resizing, cropping the view of the data, eliminating unwanted visual aspects, or enhancing desired visual aspects covering front, sides, and rear views of the object 305. Once the data set is finalized and converted into a compatible format for use by a 3-dimensional imaging machine, it can be stored on the computer IC3 301, copied to a compact disc, or transmitted over a communication link.

FIG. 4 shows a 3-dimensional digital camera C4 450 connected by a cable 410 to an image-processing computer IC4 401. The 3-dimensional digital camera C4 450 has two lenses 420 and 421 that capture visual data of an object 405, which rest on a turntable 430. The 3-dimensional camera C4 450 also has a light emitter 421, which emits a fan beam 425 of light of varying wavelengths to illuminate the object 405. The 3-dimensional camera C4 450 utilizes triangular ranging based on the color-to-angle relationship to devise range data to illuminated object 405. The turntable 430 will rotate object 405 in an optimum fashion to facilitate capturing 3-dimensional data covering all sides of object 405. This rotation of turntable 405 may be continuous at a constant rate or intermittent as the 3-dimensional digital camera C4 450 captures 3-dimensional digital images of object 405.

As the 3-dimensional digital camera C4 450 captures images of object 405, digital data is transmitted to the image-processing computer IC4 401 over cable 410. After the imaging-processing computer IC4 401 receives the data from the 3-dimensional digital camera C4 450, the data is processed by program algorithms to produce a 3-dimensional data set. This integrated data from the multiple views of the two lenses 420 and 421 is further processed and converted into a data file compatible for use by a 3-dimensional imaging machine. During image processing, the data can be further manipulated to the desired size, crop the view of the data, eliminate unwanted visual aspects, or enhance desired visual aspects covering the front, sides, and rear views of the object 405. Once the data is finalized and converted into a compatible format for use by a 3-dimensional imaging machine, it can be stored on the computer IC4 401, copied to a compact disk, or transmitted over a communication link.

FIG. 5 shows another embodiment for capturing multiple views of an object using multiple 3-dimensional digital cameras. A 3-dimensional digital camera C5 550 is linked by cable 510 to image-processing computer IC5 501. A second 3-dimensional digital camera C6 551 is connected to image-processing computer IC5 501 by cable 511. A third 3-dimensional digital camera C7 552 is connected to image-processing computer IC5 501 by cable 512. The 3-dimensional digital camera C5 550 has two lenses 520 and 521, 3-dimensional digital camera C6 551 has two lenses 522 and 523, and 3-dimensional digital camera C7 552 has two lenses 522 and 523. Three light sources 502, 503, and 504, provide illumination and range data reference during image-capture of object 505. Object 505 is positioned so that the three 3-dimensional digital cameras 550, 551, and 552 will capture a complete data set of object 505 covering all sides. Although three cameras are shown, additional cameras are possible and may enhance the quality of data captured.

As the 3-dimensional digital camera C5 550 captures images of object 505, the data is transmitted over cable 510 to image-processing computer IC5 501. As the 3-dimensional digital camera C6 551 captures images of object 505, the data is transmitted over cable 511 to image-processing computer IC5 501. As the 3-dimensional digital camera C7 552 captures images of object 505, the data is transmitted over cable 512 to image-processing computer IC5 501. The image-processing computer IC5 501 integrates and processes the data from the three 3-dimensional digital cameras 550, 551, and 552 to produce a 3-dimensional data set of all sides of the object. After this image processing, the data can be further manipulated to change the size, crop the view of the data, eliminate unwanted visual aspects, or enhance desired visual aspects covering the front, sides, and rear views of the object 505. The data is finalized and converted into a file format compatible with a 3-dimensional imaging machine. Once the data is finalized and converted into a compatible format, it can be stored on the image-processing computer IC5 501, copied to a compact disk, or transmitted over a communication link.

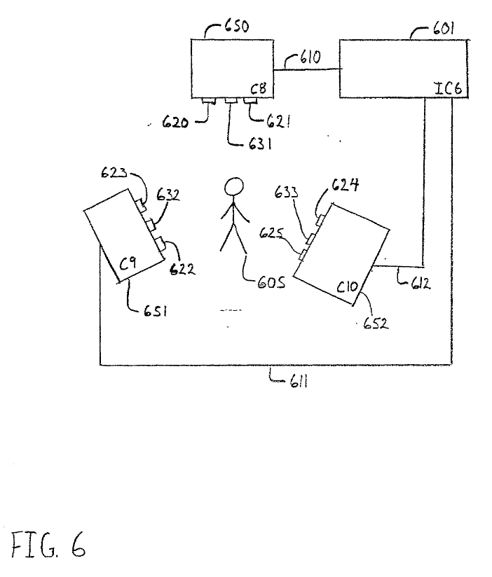

FIG. 6 shows another embodiment for capturing multiple views of an object using a fan beam light source. A 3-dimensional digital camera C8 650 is linked by cable 610 to image-processing computer IC6 601. The 3-dimensional digital camera C8 650 has two lenses 620 and 621 and a fan beam light source 631. A second 3-dimensional digital camera C9 651 is linked by cable 611 to image-processing computer IC6 601. The 3-dimensional digital camera C9 651 has two lenses 622 and 623 and a fan beam light source 632. A third 3-dimensional digital camera C10 652 is linked by cable 612 to image-processing computer IC6 601. The 3-dimensional digital camera CIO 652 has two lenses 624 and 625 and a fan beam light source 633. The three fan beam light sources 631, 632, and 633 provide illumination and range data references during image capture of object 605. Object 605 is positioned so that the three 3-dimensional digital cameras 650, 651, and 652 will capture a complete multiple view data set of object 605. Although three cameras are shown, additional cameras are possible and may enhance the quality of data captured.

As the 3-dimensional digital camera C8 650 captures the image of object 605, the data is transmitted over cable 610 to image-processing computer IC6 601. As the 3-dimensional digital camera C9 651 captures the image of object 605, the data is transmitted over cable 611 to image-processing computer IC6 601. As the 3-dimensional digital camera C10 652 captures the image of object 605, the data is transmitted over cable 612 to image-processing computer IC6 601. The image-processing computer IC6 601 integrates and processes the data from the three 3-dimensional digital cameras 650, 651, and 652 to produce a 3-dimensional data set of all sides of the object 605. During this image processing, the data can be further manipulated to change the size, crop the view of the data, eliminate unwanted visual aspects, or enhance desired visual aspects covering the front, sides, and rear views of the object 605. The data is finalized and converted into a file format compatible with a 3-dimensional imaging machine. Once the data is finalized and converted, it can be stored on the image-processing computer IC6 601, copied to a compact disk, or transmitted over a communication link.

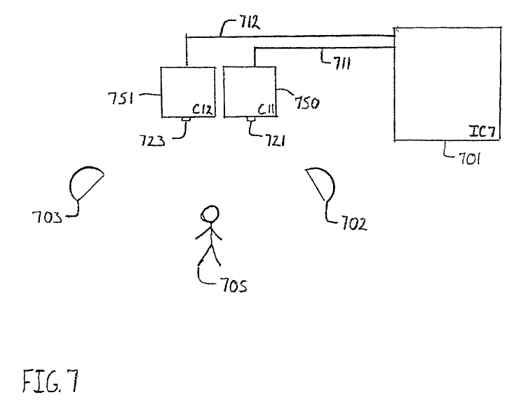

In FIG. 7, two digital cameras are used to capture a 3-dimensional image. Digital camera C11 750 is connected by cable 711 to image-processing computer IC7 701, and has a single lens 721 to capture a digital image of object 705. Digital camera C12 751 is connected by cable 712 to image-processing computer IC7 701 and has a single lens 723 to capture a digital image of object 705. Two light sources 702 and 703 provide illumination and are used to provide range data references to object 705.

As digital camera C11 750 captures image data of object 705, the data is transmitted over cable 711 to image-processing computer IC7 701. As digital camera C12 751 captures image data of object 705, the data is transmitted over cable 712 to image-processing computer IC7 701. The image-processing computer IC7 701 integrates and processes the data from the two digital cameras 750 and 751 to generate a 3-dimensional image data set. During this image processing, the data can be further manipulated to change the size, crop the view of the data, eliminate unwanted visual aspects, or enhance visual aspects of object 705. Once the data is finalized, it is converted into a compatible format for use by a 3-dimensional imaging machine. Once the data is converted, it can be stored on the image-processing computer IC7 701, copied to a compact disk, or transmitted over a communications link.

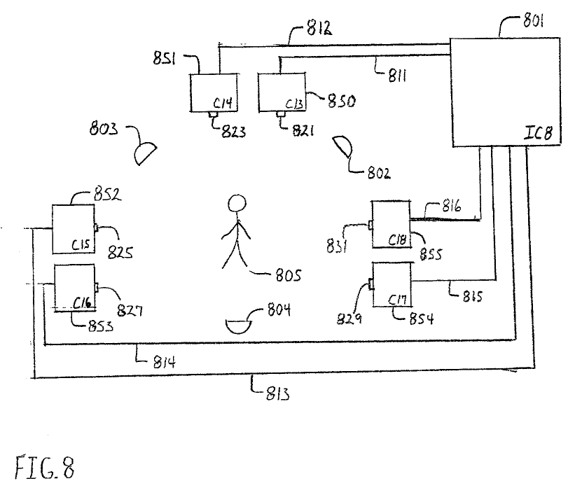

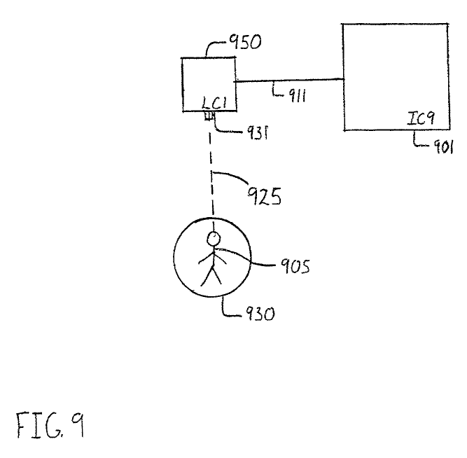

FIG. 8 shows an alternate embodiment using multiple digital cameras to capture multiple views. Digital camera C13 850 is connected by cable 811 to image-processing computer IC8 801 and has a single lens 821 to capture a digital image of object 805. Digital camera C14 851 is connected by cable 812 to image-processing computer IC8 801 and has a single lens 823 to capture a digital image of object 805. Digital camera C15 852 is connected to image-processing computer IC8 801 by cable 813 and has a single lens 825 to capture a digital image of object 805. Digital camera C16 853 is connected by cable 814 to image-processing computer IC8 801 and has a single lens 827 to capture a digital image of object 805. Digital camera C17 854 is connected by cable 815 to image-processing computer IC8 801 and has a single lens 829 to capture a digital image of object 805. Digital camera C18 855 is connected by cable 816 to image-processing computer IC8 801 and has a single lens 831 to capture a digital image of object 805. Light sources 802, 803, and 804 illuminate object 805 and are used to provide range data reference.

The six digital cameras 850, 851, 852, 853, 854, and 855 are arranged around object 805, so that the digital images captured can be processed by the image-processing computer IC8 801 to generate a 3-dimensional data set of object 805 covering multiple views. Although six cameras are shown, alternative embodiments using fewer or more are possible. As data is captured by digital camera C13 850, the data is transmitted over cable 811 to the image-processing computer IC8 801. As data is captured by digital camera C14 851, the data is transmitted over cable 813 to image-processing computer IC8 801. As data is captured by digital camera C15 852, the data is transmitted over cable 812 to image-processing computer IC8 801. As data is captured by digital camera C16 853, the data is transmitted over cable 814 to image-processing computer IC8 801. As data is captured by digital camera C17 854, the data is transmitted over cable 815 to image-processing computer IC8 801. As data is captured by digital camera C18 855, the data is transmitted over cable 816 to image-processing computer IC8 801. The image-processing computer IC8 801 integrates and processes the information from the six digital cameras to generate a 3-dimensional data set. During the image-processing, the data can be further manipulated to change the size, crop the view of the data, eliminate unwanted visual aspects, or enhance visual aspects covering the front, sides, and rear of object 805. Once the data is finalized, it is converted into a compatible format for use by a 3-dimensional imaging machine. The converted data can be stored on the image-processing computer IC8 801, copied to a compact disk, or transmitted over a communications link.

Another possible method of capturing range or depth data in 3-dimensional photography is to use a laser to make the measurements. FIG. 9 shows an embodiment using laser technology. A 3-dimensional laser camera LC1 950 is used to capture data sets of object 905. The 3-dimensional laser camera LC1 950 has an aperture 931 and is connected by cable 911 to an image-processing computer IC9 901. Aperture 931 will emit a laser beam 925 toward object 905. Object 905 rests on a turntable 930. A laser scanner can also be used instead of a laser camera.

The laser camera LC1 950 emits a laser beam 925 to capture range data of object 905. 3-dimensional laser camera LC1 950 may have a single lens 931 that both emits the laser beam and captures a digital image of an object 905, or there may be two separate apertures, one emitting a beam 925 and the other capturing a digital picture of object 905. The laser beam 925 itself needs to be eye safe so that images of people or animals can be captured safely. The object 905 can be placed on a turntable 930, which is rotated in an optimum fashion to facilitate capturing 3-dimensional data sets for every side of object 905. This rotation of turntable 905 may be continuous at a constant rate or intermittent as the 3-dimensional laser camera LC1 950 captures 3-dimensional images or data of object 905. As the 3-dimensional laser camera LC1 950 captures the 3-dimensional data of object 905, the data is transmitted to the image-processing computer IC9 901 over cable 911. After the image-processing computer IC9 901 receives the data, the data is processed and integrated to produce a 3-dimensional data set of object 905. During image manipulation on computer IC9 901, the data can be further manipulated and edited to the desired size and visual quality. Once the data set is finalized, it is processed and converted onto a compatible format for use by a 3-dimensional imaging machine. The data can then be stored on the computer IC9 901, copied to a compact disk, or transmitted over a communication link.

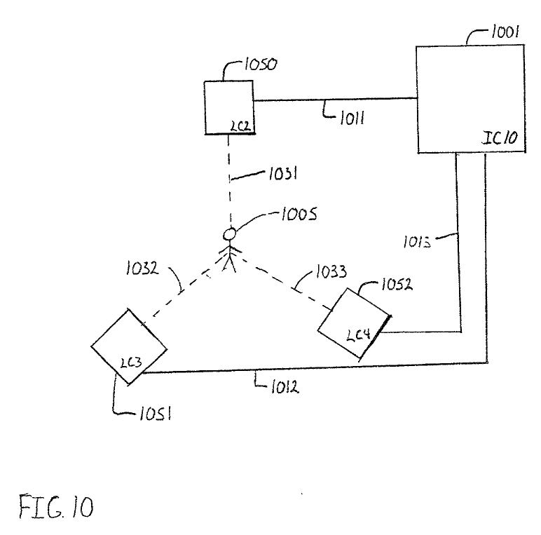

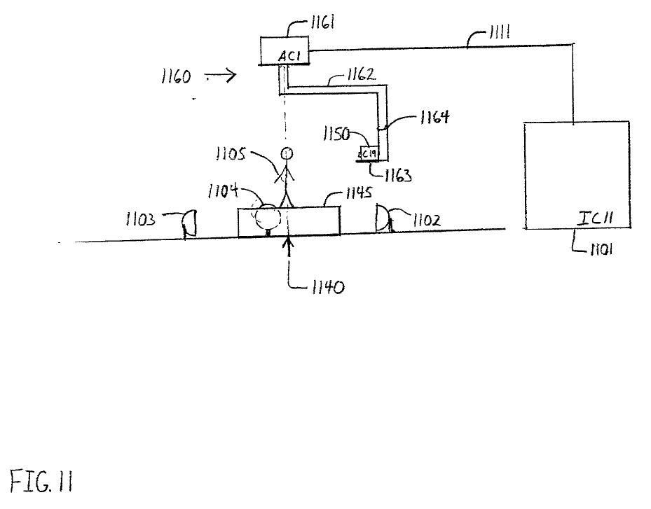

FIG. 10 shows another embodiment for capturing multiple data sets using multiple 3-dimensional laser cameras. A 3-dimensional laser camera LC2 1050 with a laser beam 1031 for capturing range data is connected by cable 1011 to image-processing computer IC10 1001. Another 3-dimensional laser camera LC3 1051 with a laser beam 1032 for capturing image data is connected by cable 1012 to image-processing computer IC10 1001. A final 3-dimensional laser camera LC4 1052 with a laser beam 1033 is connected by cable 1013 to image-processing computer IC10 1001.

As 3-dimensional laser camera LC2 1050 captures 3-dimensional data of object 1005, the data is transmitted over cable 1011 to image-processing computer IC10 1001. As 3-dimensional laser camera LC3 1051 captures 3-dimensional data of object 1005, the data is transmitted over cable 1012 to image-processing computer IC10 1001. As 3-dimensional laser camera LC4 1052 captures 3-dimensional data of object 1005, the data is transmitted over cable 1013 to image-processing computer IC10 1001. A laser scanner can be substituted for one or all of the laser cameras. The image-processing computer IC10 1001 integrates and processes the data from the three cameras 1050, 1051, and 1052 to generate a 3-dimensional data set of object 1005. The data set can be resized, cropped, or otherwise manipulated to enhance or eliminate various features. Once the data set is finalized, it is processed and converted into a compatible format for use by a 3-dimensional imaging machine. The data can then be stored on the image-processing computer IC10 1001, copied to a compact disk, or transmitted over a communication link.

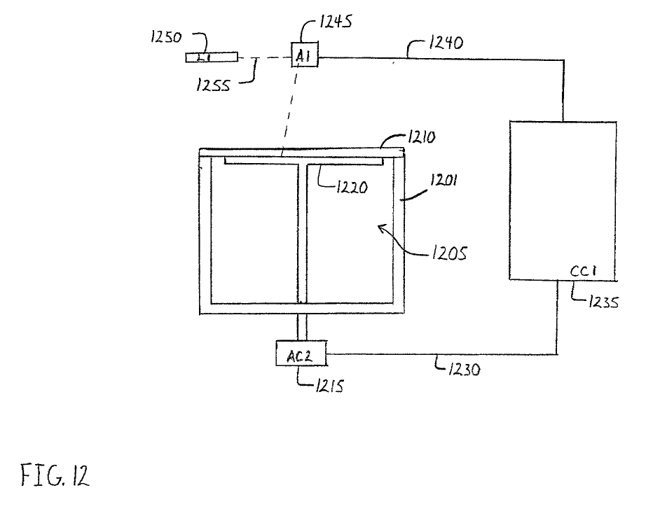

FIG. 11 is another possible embodiment for capturing a multiple 3-dimensional data set of an object. A 3-dimensional camera C19 1150 is mounted on a panning system 1160 that rotates around a central point 1140. A support arm 1162 extends downward from an actuator AC1 1161 on the ceiling. A support bracket or mount 1163 is attached to the support arm 1162 on the end opposite from the actuator AC1 1161. The camera C19 1150 is mounted on the mount 1163. The support arm 1162 also has a telescoping joint 1164. A raised platform, chair, bench, pedestal or similar artifice 1145 rests on the central point 1140, and the object 1105 being captured is placed on the artifice 1145 for a 3-dimensional image to be taken. There are three light sources 1102, 1103, and 1104. The telescoping connection at 1164 permits the camera C19 1150 to be raised or lowered into the best position to take an image. A communication link 1111 connects an image-processing computer IC11 1101 to the actuator AC1 1161 and the camera C19 1150.

The 3-dimensional camera C19 1150 may require an exterior light source to provide illumination and range data. Light sources 1102, 1103, and 1104 provide illumination and range data during image capture. Two or more lights are needed to facilitate range data capture of multiple views. However, 3-dimensional camera C19 1150 may have a built-in mechanism to derive range data such as a fan beam of light, a laser, or a light pulse. Alternatively, a ranging mechanism may be built into the support bracket 1163.

To capture a 3-dimensional image of object 1105, the operator adjusts the height of the camera C19 1150 above the floor using telescoping joint 1164. Panning system 1160 is activated, so that the actuator AC1 1161 rotates the support arm 1162, which rotates the camera C19 1150 around the object 1105. This rotation is in a manner to best facilitate capturing multiple views of object 1105 and may be at a constant rate or intermittent. The image-processing computer IC11 1101 also controls the movement using communication link 1111. Light sources 1102, 1103, and 1104 provide illumination, and if required, are used to provide range data. As the 3-dimensional camera C19 1150 captures the visual data, the data is transmitted by cable 1111 to the image-processing computer IC11 1101. The image-processing computer IC11 1101 integrates and processes the data from the camera C19 1150 to generate a 3-dimensional data set of object 1105. The data set can be resized, cropped, or otherwise manipulated to enhance or eliminate various features.

Once the data set is finalized, it is processed and converted into a compatible format for use by a 3-dimensional imaging machine. This data can then be stored on the computer IC11 1101, copied to a compact disk, or transmitted over a communications link. Although this embodiment shows a single computer IC11 1101 controlling the panning system 1160 and processing the image data, there could be two computers. One computer would control the panning system 1160, and the other would be used to integrate and process the image data.

Other alternative embodiments are possible to capture a 3-dimensional image of an object. The essential process in the invention is to capture a 3-dimensional data set of an object, manipulate and process the data to generate an aesthetically pleasing image for reproduction as an art object to the specification of a consumer, and convert the data into a format compatible with the 3-dimensional imaging machine that will construct the object from the 3-dimensional image data.

3-Dimensional Imaging

After a 3-dimensional data set is generated and converted into a compatible data file format, the file can be used by a 3-dimensional imaging machine to create a replica using the 3-dimensional image data set. This replica can either be a duplicate of the item that a 3-dimensional image was taken of or a mold that can be used to cast a duplicate of the item.

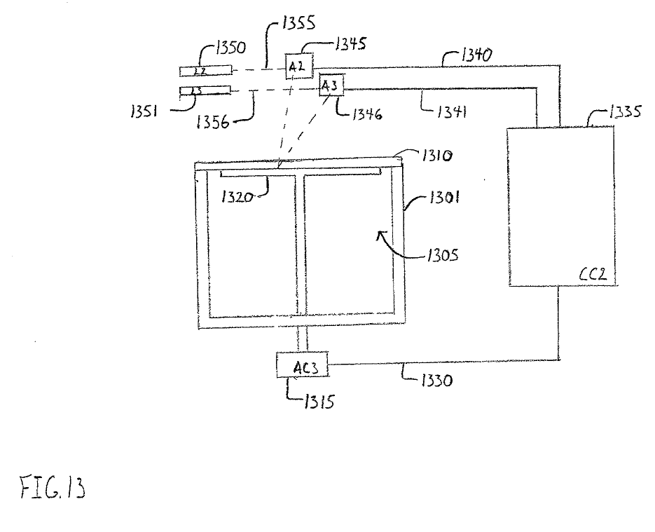

FIG. 12 shows one embodiment of a 3-dimensional imaging machine. A reaction vat 1201 is filled with a UV sensitive liquid resin 1205 and covered by a protective window 1210. An actuator AC2 1215 is connected to and moves an elevator platform 1220 inside the reaction vat 1201. The actuator AC2 1215 is linked by control link 1215 to a controller computer CC1 1235, which is also linked to a laser beam aimer A1 1245 by control link 1240. A UV laser L1 1250 generates a UV laser beam 1255, which the aimer A1 1245 aims.

The 3-dimensional data file to be replicated is uploaded onto the controller computer CC1 1235. The elevator 1220 starts out immersed in the resin 1205 to the same depth corresponding to the thickness of the 3-dimensional data slice being replicated of the file, in this case the bottom layer. The UV laser L1 1250 emits a laser beam of UV light 1255, which the controller computer CC1 1235 controls using aimer A1 1245 by control signals sent over control link 1240 to aim and redirect the laser beam 1255 to trace out the bottom layer of the 3-dimensional object on the top of the elevator platform 1220. Where the laser beam 1255 strikes the UV sensitive resin 1205, it solidifies into a hard plastic. After the controller computer CC1 1235 finishes tracing the layer, the controller computer CC1 1235 sends a control signal over control link 1230 to the actuator AC2 1215 to lower the elevator platform 1220 by an amount equal to the thickness of the next slice of data. Once this happens, fresh resin 1205 flows over the hardened plastic. The process then repeats to form the next layer of the object and continues until the object has been built, layer-by-layer.

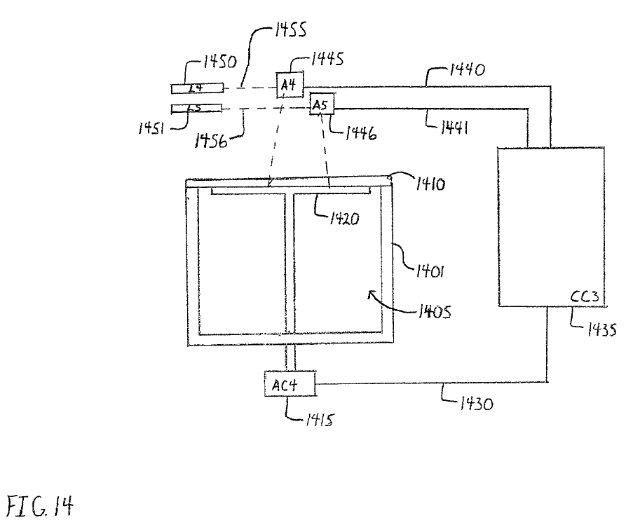

An alternative embodiment in FIG. 13 shows a reaction vat 1301 filled with a UV sensitive liquid resin 1305 covered by a protective window 1310. An actuator AC3 1315 is connected to and moves an elevator platform 1320 inside the reaction vat 1301. The actuator AC3 1315 is linked by control link 1330 to a controller computer CC2 1335. The controller computer CC2 1335 is connected by control link 1340 to aimer A2 1345 and by control link 1341 to aimer A3 1346. UV laser L2 1350 generates laser beam 1355, and UV laser L3 1351 generates laser beam 1356. Laser beam 1355 is aimed by aimer A2 1345, and laser beam 1356 is aimed by aimer A3 1346. The controller computer CC2 1335 controls aimers 1345 and 1346, so that the laser beams 1355 and 1356 intersect on the surface of elevator platform 1320.

The 3-dimensional data file to be replicated is uploaded onto the controller computer CC2 1335. The elevator platform 1320 starts out immersed in the resin 1305 to the same depth corresponding to the thickness of the 3-dimensional data slice of the file to be replicated, in this case the bottom layer. The UV laser L2 1350 emits a beam 1355 of UV light, and UV laser L3 1351 emits a beam 1356 of UV light. UV laser beam 1355 is aimed by aimer A2 1345, which is controlled by the controller computer CC2 1335 over control link 1340. UV laser beam 1356 is aimed by aimer A3 1346, which is controlled by the controller computer CC2 1335 over control link 1341.

The two laser beams, 1355 and 1356, are aimed to intersect on the surface of elevator platform 1320. The controller computer CC2 1335 controls the beams 1355 and 1356 to trace out the bottom layer of the 3-dimensional object on top of the elevator platform 1320. Where the intersecting laser beams 1355 and 1356 strike the resin 1305, the resin solidifies into a hard plastic. After the controller computer CC2 1335 finishes tracing the layer, the controller computer CC2 1335 sends a control signal over control link 1330 to the actuator AC3 1315 to lower the elevator platform 1320 by an amount equal to the data's thickness of the next layer. Once this happens, fresh resin 1305 flows over the hardened plastic. The process then repeats to form the next layer until the entire file is replicated.

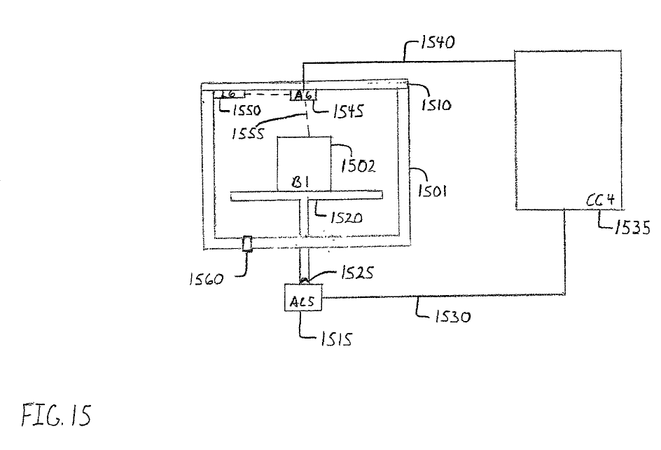

FIG. 14 shows an alternative embodiment for using two lasers. A reaction vat 1401 is filled with UV sensitive liquid resin 1405 covered by a protective window 1410. An actuator AC4 1415 is connected to and moves an elevator platform 1420 inside the reaction vat 1401. The actuator AC4 1415 is linked by control link 1430 to a controller computer CC3 1435. The controller computer CC3 1435 is connected by control link 1440 to aimer A4 1445 and is connected by control link 1441 to aimer A5 1446. UV laser L4 1450 generates laser beam 1455, and UV laser L5 1451 generates laser beam 1456. Laser beam 1455 is aimed by aimer A4 1445, and laser beam 1456 is aimed by aimer A5 1446. The controller computer CC3 1435 controls aimer A4 1445 over control link 1440 and aimer A5 1446 over control link 1441.

The 3-dimensional data file to be replicated is uploaded onto the controller computer CC3 1435. The elevator platform 1420 starts out immersed in the resin 1405 to the same depth corresponding to the thickness of the 3-dimensional data slice in the file being replicated, in this case the first layer. The UV laser L4 1450 emits a laser beam 1455 of UV light, and UV laser L5 1451 emits a laser beam 1456 of UV light. UV laser beam 1455 is aimed by aimer A4 1445, which is controlled by the controller computer CC3 1435 over control link 1440. UV laser beam 1456 is aimed by aimer A5 1446, which is controlled by the controller computer CC3 1435 over control link 1441.

The two laser beams, 1455 and 1456, are aimed at the surface of the elevator platform 1420 so that each beam traces out approximately one-half of the bottom layer of the 3-dimensional object on top of the elevator platform 1420. This significantly reduces the time to trace out an image compared to a single laser beam. Where the beams 1455 and 1456 strike the resin 1405, it solidifies into a hard plastic. Alternatively, the controller computer CC3 1435 can control the beams 1455 and 1456 so that both trace the layer successively, which would ensure that all the resin in the layer was completely cured into plastic. After the controller computer CC3 1435 finishes tracing the layer with the two lasers, the controller computer CC3 1435 sends a control signal over control link 1430 to the actuator AC4 1415 to lower the elevator platform 1420 by an amount equal to the data's thickness for the next layer. Once this happens, fresh resin 1405 flows over the hardened plastic. The process than repeats for the next layer and continues until the object is completed.

Another embodiment for producing an object from 3-dimensional image data is shown in FIG. 15 in which the object is formed by removing material rather than adding material. A work cabinet 1501 covered by a protective window 1510 contains a block B1 1502 of material. The block B1 1502 rests upon a tiltable turntable 1520. The tiltable turntable 1520 is connected to and rotated by an actuator AC5 1515, which includes a tilt mechanism 1525. The actuator AC5 1515 is connected by a control link 1530 to a controller computer CC4 1535. Another control link 1540 connects the controller computer CC4 1535 to an aimer A6 1545. A laser L61550 emits a laser beam 1555, which is aimed by aimer A6 1545 to hit the block B1 1502. The cabinet 1501 has an exhaust 1560 to remove any vapors, gases, or particulates from inside cabinet 1501.

As the laser beam 1555 hits the block B1 1502, it causes a small amount of material to vaporize, subliminate, burn, or etch away. The controller computer CC4 1535 controls where material is removed from block B1 1502 by aiming the laser beam 1555 using control link 1540 to the aimer A6 1545 and rotating and tilting turntable 1520 using control link 1530 to control the actuator AC5 1515 and tilt mechanism 1525. The laser beam 1555 gradually removes material from the block B1 1502 a bit at a time until the 3-dimensional image file is completely replicated.

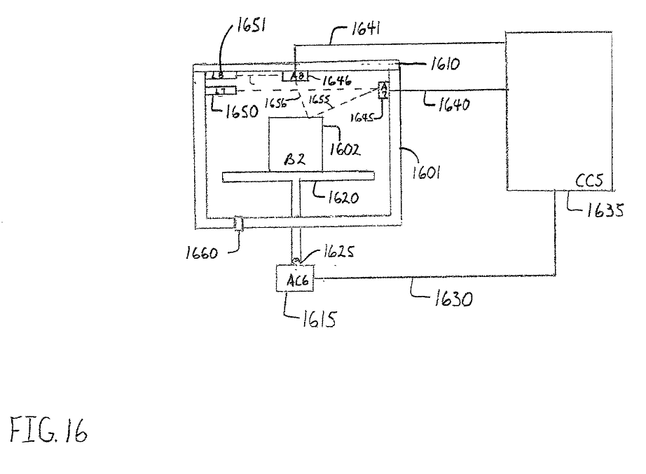

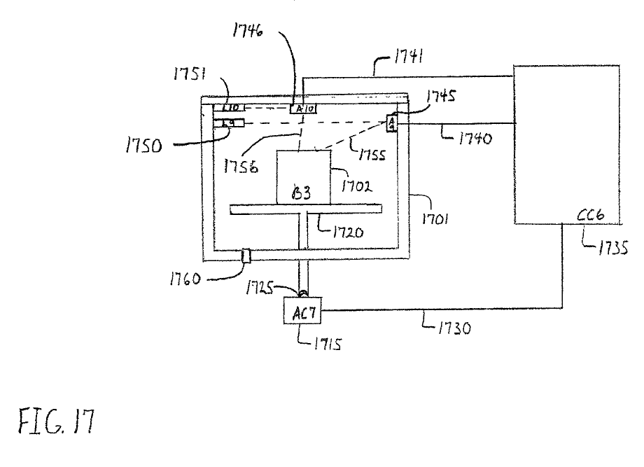

Another embodiment for removing material gradually from a block of material is shown in FIG. 16. A work cabinet 1601 covered by a protective window 1610 contains a block B2 1602 of material. The block B2 1602 rests upon a tiltable turntable 1620. The tiltable turntable 1620 is connected to and rotated by an actuator AC6 1615, which includes a tilt mechanism 1625. The actuator AC6 1615 is connected by a control link 1630 to a controller computer CC5 1635. Another control link 1640 connects the controller computer CC5 1635 to a laser aimer A7 1645. Another control link 1641 connects the controller computer CC5 1635 to a second laser aimer A8 1646. Laser L7 1650 emits a laser beam 1655 that is aimed by aimer A7 1645. Laser L8 1651 emits a laser beam 1656 aimed by aimer A8 1646. The work cabinet 1601 also has an exhaust 1660.

The laser L7 1650 emits beam 1655, which is aimed by aimer A7 1645 to strike block B2 1602. Laser L8 1651 emits beam 1656, which is aimed by aimer A7 1645 to intersect with beam 1655 and strike block B2 1602 at the same point. As the intersecting laser beams 1655 and 1656 strike block B2 1602, they cause a small amount of material to vaporize, subliminate, burn, or etch away. The controller computer CC5 1635 controls where material is removed from block B2 1602 by aiming the intersection of the two beams 1655 and 1656 using control link 1640 and 1641 to aimers 1645 and 1646 respectively and rotating and tilting turntable 1620 using control link 1630 to control the actuator AC6 1615 and tilt mechanisms 1625. As block B2 1602 material is removed, the exhaust 1660 removes any particulates, gases, or vapors produced. The laser beams 1655 and 1656 gradually remove material from the block B2 1602 a bit at a time until the 3-dimensional image is replicated.

FIG. 17 shows another alternative embodiment for removing material and replicating a 3-dimensional data file. A work cabinet 1701 covered by a protective window 1710 contains a block B13 1702 of material. The block B3 1702 rests upon a tiltable turntable 1720. The tiltable turntable 1720 is connected to and rotated by an actuator AC7 1715, which includes a tilt mechanism 1725. The actuator AC7 1715 is connected by a control link 1730 to a controller computer CC6 1735. Another control link 1740 connects the controller computer CC6 1735 to a laser aimer A9 1745. Another control link 1741 connects the controller computer CC6 1735 to a laser aimer A10 1746. Laser L9 1750 emits a laser beam 1755 that is aimed by aimer A9 1745. Laser L10 1751 emits a laser beam 1756 that is aimed by aimer A10 1746. The protective cabinet 1701 also has an exhaust 1760.

The laser L9 1750 emits laser beam 1755, which is aimed by aimer A9 1745 to strike block B3 1702. Laser L10 1751 emits laser beam 1756, which is aimed by aimer A10 1746 to strike block B3 1702 at a different point. As the two laser beams 1755 and 1756 hit block B3 1702, they cause a small amount to vaporize, subliminate, burn, or etch away. The controller computer CC6 1735 controls where material is removed form block B3 1702 by aiming the two beams 1755 and 1756 using control links 1740 and 1741 to aimer A9 1745 and 1746 respectively and rotating and tilting turntable 1720 using control link 1730 to control the actuator AC7 1715 and tilt mechanism 1725. As block B3 1702 material is removed, the exhaust 1760 removes any particulates, gases, or vapors produced. The laser beams 1755 and 1756 gradually remove material from block B3 1702 a bit at a time until the 3-dimensional image is replicated.

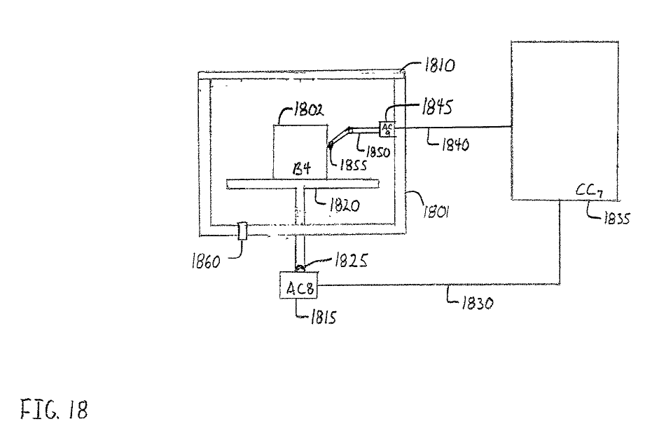

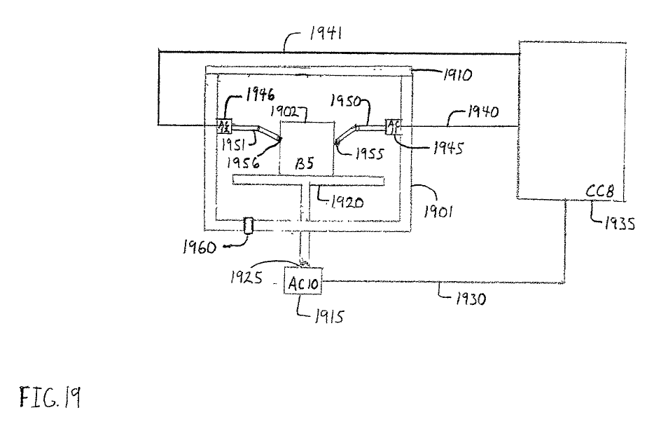

FIG. 18 shows another embodiment for replicating a 3-dimensional image from a block of material. A work cabinet 1801 covered by a protective window 1810 contains a block B4 1802 of material. The block B4 1802 rests upon a tiltable turntable 1820. The tiltable turntable 1820 is connected to and rotated by an actuator AC8 1815, which includes a tilt mechanism 1825. The actuator AC8 1815 is connected by a control link 1830 to a controller computer CC7 1835. The controller computer CC7 1835 is connected by control link 1850 to a second actuator AC9 1845. The second actuator AC9 1845 moves and controls jointed arm 1850. The end of the jointed arm 1850 is a cutting head 1855. The cabinet 1801 also has an exhaust 1860.

The controller computer CC7 1835 controls where material is removed form the block B4 1802 by controlling movement of the cutting head 1855 and tilting and rotating turntable 1820. The controller computer CC7 1835 uses control link 1840 to control movement of the cutting head 1855 with control signals over control link 1840 to the actuator AC9 1845 and cutting head 1855. The actuator AC9 1845 moves and controls the jointed arm 1850 to control movement and removal of material from block B4 1802 using cutting head 1855. The cutting head 1855 may use a laser, a mechanical cutter or grinder, a thermal source, an ultrasound source, a solvent or other chemical, or some other mechanism to remove material from block B4 1802. The controller computer CC7 1835 also uses control link 1830 to control rotation and tilting of the turntable 1820 using the actuator AC8 1815 and tilting mechanism 1825 to control removal of material. Any particulates, gases, or vapors produced inside the cabinet 1801 are removed by the exhaust 1860.

FIG. 19 is another alternative embodiment with a work cabinet 1901 covered by a protective window 1910 containing a block B5 1902 of material. The block B5 1902 rests upon a tiltable turntable 1920. The tiltable turntable 1920 is connected to and rotated by an actuator AC10 1915, which includes a tilt mechanism 1925. The actuator AC10 1915 is connected by a control link 1930 to a controller computer CC8 1935. The controller computer CC8 1935 is connected by control link 1940 to a second actuator AC11 1945. The second actuator AC11 1945 controls the movement of a jointed arm 1950. The end of the jointed arm 1950 is a cutting head 1955. The controller computer CC8 1935 is connected by another control link 1941 to a third actuator AC12 1946. The third actuator AC12 1946 controls the movement of a jointed arm 1951. The end of the jointed arm 1951 is another cutting head 1956. The cabinet 1901 also has an exhaust 1960.

The controller computer CC8 1935 controls where material is removed from the block B5 1902 by controlling movement of the cutting heads 1955 and 1956 and tilting and rotating the turntable 1920. The controller computer CC8 1935 uses control link 1940 to control movement of the cutting head 1955. The controller computer CC8 1935 uses control link 1940 to control the actuator AC11 1945. The actuator AC11 1945 moves the jointed arm 1950 and controls movement and action of the cutting head 1955 to remove material from block B5 1902. The controller computer CC8 1935 uses control link 1941 to control movement of the cutting head 1956. The controller computer CC8 1935 uses control link 1941 to control the actuator AC12 1946. The actuator AC12 1946 moves the jointed arm 1951 and controls movement and action of the cutting head 1956 to remove material from block B5 1902. The cutting heads 1955 and 1956 may use a laser, a mechanical cutter or grinder, a thermal source, an ultrasound source, a solvent or other chemical, or some other mechanism to remove material from block B5 1902. The controller computer CC8 1935 also uses control link 1930 to control the rotation and tilt of the turntable 1920 using the actuator AC10 1915 and tilting mechanism 1925. Any particulates, gases, or vapors produced inside the cabinet 1901 are removed by the exhaust 1960. The controller computer CC8 1935 uses these control links and actuators to control where material is removed from the block B5 1902. The process of removing material continues until the file is completely replicated.

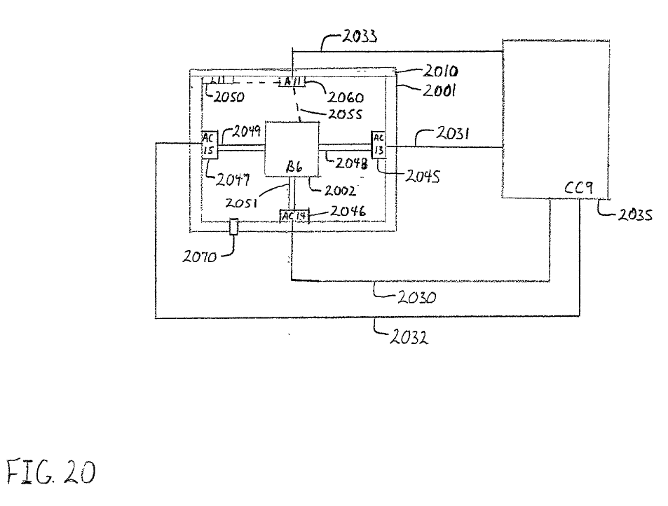

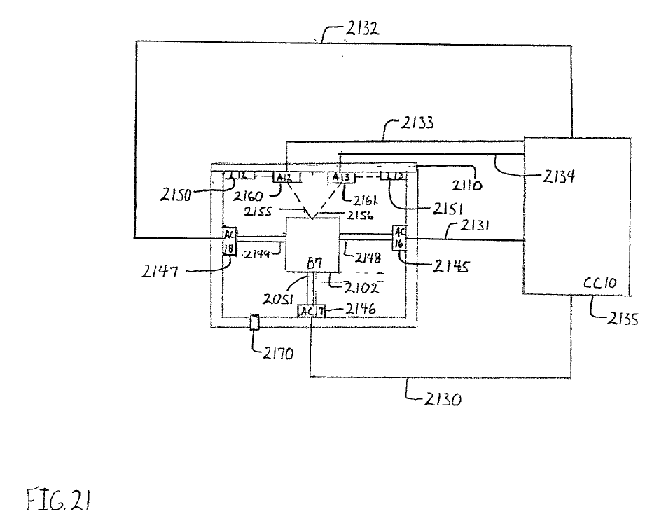

FIG. 20 is another embodiment and shows a work cabinet 2001 covered by a protective window 2010 containing a block B6 2002 of material. On two sides of the work cabinet 2001 there are two actuators, 2045 and 2047. There is a third actuator AC14 2046 on the bottom of the cabinet 2001. Actuator AC13 2045 is attached to and controls movement of a manipulator 2048. Actuator AC15 2047 is attached to and controls movement of a manipulator 2049. Actuator AC14 2046 is attached to and controls movement of a manipulator 2051. The manipulators 2048, 2049, and 2051 support, grasp, and manipulate block B6 2002. Actuator AC13 2045 is connected to a controller computer CC9 2035 by control link 2031. Actuator AC14 2046 is connected to controller computer CC9 2035 by control link 2030. Actuator AC15 2047 is connected to controller computer CC9 2035 by control link 2030. The controller computer CC9 2035 is connected to a laser aimer A11 2060 inside the work cabinet 2001 by control link 2033. A laser L11 2050 inside the work cabinet 2001 emits a laser beam 2055, which is aimed by aimer A11 2060. The cabinet 2001 also has an exhaust 2070.

The controller computer CC9 2035 controls where material is removed from the block B6 2002 by aiming the laser beam 2055 and manipulating the block B6 2002 using manipulators 2048, 2049, and 2051. The controller computer CC9 2035 uses control link 2033 to aimer A11 2060 to aim the laser beam 2055 at the block B6 2002. As the laser beam 2055 strikes block B6 2002, it causes a small amount of material to vaporize, subliminate, bum, or etch away. The controller computer CC9 2035 controls manipulation by manipulator 2048 using control link 2031 to control actuator AC13 2045. The controller computer CC9 2035 controls the manipulation by manipulator 2049 using control link 2032 to control actuator AC15 2047. The controller computer CC9 2035 controls the manipulation by manipulator 2051 using control link 2030 to control actuator AC14 2046. Although three manipulators are shown, more or fewer are possible. As block B6 2002 material is removed, the exhaust 2070 removes any particulates, gases, or vapors produced. The laser beam 2055 gradually removes material form block B6 2002 a bit at a time until the 3-dimensional image is replicated.

FIG. 21 is another alternative embodiment for removing material from a block of material using lasers and manipulators. A work cabinet 2101 covered by a protective window 2110 contains a block B7 2102 of material. On two sides of the work cabinet 2101 there are two actuators, 2145 and 2147. There is a third actuator AC17 2146 on the bottom of the cabinet 2101. Actuator AC16 2145 is attached to and controls movement of a manipulator 2148. Actuator AC18 2147 is attached to and controls movement of a manipulator 2149. Actuator AC17 2146 is attached to and controls movement of a manipulator 2151. The manipulators 2148, 2149, and 2151 support and grasp block B7 2102. Actuator AC16 2145 is connected to a controller computer CC10 2135 by control link 2131. Actuator AC17 2146 is connected to a controller computer CC10 2135 by control link 2130. Actuator AC18 2147 is connected to a controller computer CC10 2135 by control link 2132. The controller computer CC10 2135 is connected to a laser aimer A12 2160 by control link 2133. The controller computer CC10 2135 is connected to a second laser aimer A13 2161 by control link 2134. A laser L13 2151 emits a laser beam 2156, which is aimed by aimer A13 2161. A laser L12 2150 emits a laser beam 2155, which is aimed by aimer A12 2160. The cabinet 2101 also has an exhaust 2170.

The controller computer CC10 2135 controls where material is removed form the block B7 2102 by aiming the laser beams 2155 and 2156 and manipulating the block B6 2002. The controller computer CC10 2135 uses control link 2133 to control aimer A12 2160 to aim the laser beam 2155 at the block B7 2102. The computer controller 2135 uses control link 2134 to control aimer A13 2161 and aim laser beam 2156 at the block B7 2102. The two laser beams 2155 and 2156 are aimed to intersect at the same point on block B7 2102. As the two intersecting laser beams 2155 and 2156 strike block B7 2102, they cause a small amount of material to vaporize, subliminate, burn, or etch away. The controller computer CC10 2135 controls where material is removed by aiming the beams 2155 and 2156 and manipulating the block B7 2102 using the manipulators 2148, 2149, and 2151. The controller computer CC10 2135 controls the manipulation of manipulator 2148 by using control link 2131 to control actuator AC16 2145. The controller computer CC10 2135 controls the manipulation of manipulator 2149 by using control link 2132 to control actuator AC18 2147. The controller computer CC10 2135 controls the manipulation of manipulator 2151 by using control link 2130 to control actuator AC17 2146. Although three manipulators are shown, more or fewer are possible. As block B7 2102 material is removed, the exhaust 2170 removes any particulates, gases, or vapors produced. The laser beam 2155 gradually removes material from block B7 2102 a bit at a time until the 3-dimensional image is replicated.

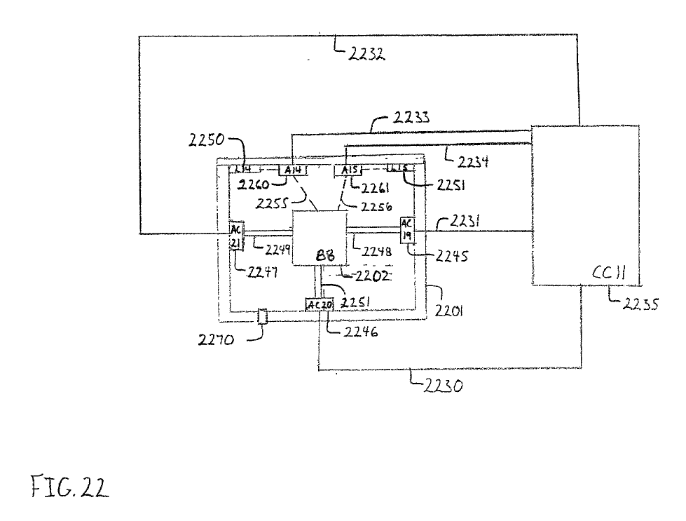

FIG. 22 shows another alternative embodiment for removing material from a block of material using two lasers. A work cabinet 2201 covered by a protective window 2210 contains a block B8 2202 of material. On two sides of the work cabinet 2201 there are two actuators, 2245 and 2247. There is a third actuator AC20 2246 on the bottom of the cabinet 2201. Actuator AC19 2245 is attached to and controls movement of a manipulator 2248. Actuator AC21 2247 is attached to and controls movement of a manipulator 2249. Actuator AC20 2246 is attached to and controls movement of a manipulator 2251. The manipulators 2248, 2249, and 2251 support, grasp, and manipulate block B8 2202. Actuator AC19 2245 is connected to a controller computer CC11 2235 by control link 2231. Actuator AC20 2246 is connected to a controller computer CC11 2235 by control link 2230. Actuator AC21 2247 is connected to a controller computer CC11 2235 by control link 2232. The controller computer CC11 2235 is connected to a laser aimer A14 2260 inside the cabinet 2201 by control link 2233. The controller computer CC11 2235 is connected to a laser aimer A15 2261 inside the cabinet 2201 by control link 2234. A laser L14 2250 inside the cabinet 2201 emits a laser beam 2255, which is aimed by aimer A14 2260. A laser L15 2251 inside the cabinet 2201 emits a laser beam 2256, which is aimed by aimer A15 2261. The cabinet 2201 also has an exhaust 2270.

The controller computer CC11 2235 controls where material is removed from the block B8 2202 by aiming the laser beams 2255 and 2256 and manipulating the block B8 2202. The controller computer CC11 2235 uses control link 2233 to aim laser beam 2255 using aimer A14 2260. The controller computer CC11 2235 uses control link 2234 to aim laser beam 2256 using aimer A15 2261. The controller computer CC11 2235 aims the two beams, 2255 and 2256, at different points on the block B8 2202. As the laser beam 2255 and 2256 strike block B8 2202, the beams cause a small amount of material to vaporize, subliminate, burn, or etch away. The controller computer CC11 2235 also controls where material is removed by manipulating block B8 2202 using the manipulators 2248, 2249, and 2251. The controller computer CC11 2235 controls the manipulation of manipulator 2248 by using control link 2231 to control actuator AC19 2245. The controller computer CC11 2235 controls the manipulation of manipulator 2249 by using control link 2232 to control actuator AC21 2247. The controller computer CC11 2235 controls the manipulation of manipulator 2251 by using control link 2230 to control actuator AC20 2246. Although three manipulators are shown, more or fewer are possible. As block B8 2202 material is removed, the exhaust 2270 removes any particulates gases, or vapors produced. The laser beams 2255 and 2256 gradually remove material from block B8 2202 a bit at a time until the 3-dimensional image is replicated.

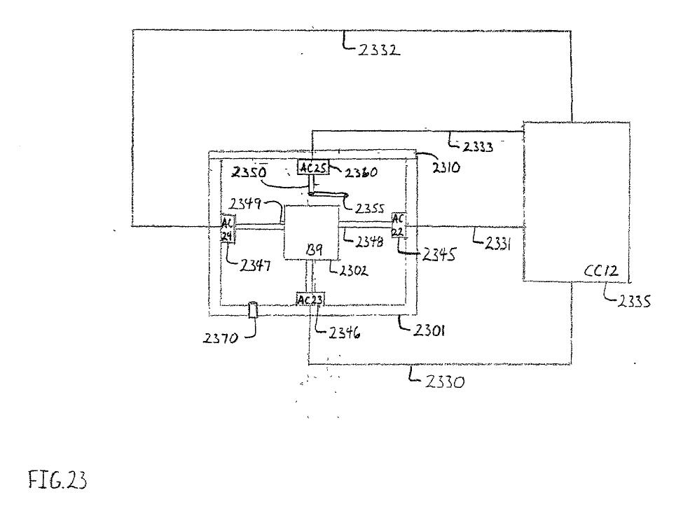

FIG. 23 shows a work cabinet 2301 covered by protective window 2310 with a block B9 2302 of materials inside. On two sides of the work cabinet 2301 there are two actuators, 2345 and 2347. A third actuator AC23 2346 is on the bottom of the work cabinet 2301. Actuator AC22 2345 is attached to and controls movement of a manipulator 2348. Actuator AC24 2347 is attached to and controls movement of a manipulator 2349. Actuator AC23 2346 is attached to and controls movement of manipulator 2351. The manipulators 2348, 2349, and 2351, support, grasp, and manipulate block B9 2302. Actuator AC22 2345 is connected to a controller computer CC12 2335 by control link 2331. Actuator AC23 2346 is connected to a controller computer CC12 2335 by control link 2330. Actuator AC24 2347 is connected to a controller computer CC12 2335 by control link 2332. Controller computer CC12 2335 is connected to another actuator AC25 2360 by control link 2333. Actuator AC25 2360 is connected to and controls the movement of a jointed arm 2350. The end of jointed arm 2350 is a cutting head 2355. The cabinet 2301 also has an exhaust 2370.

The 3-dimensional image data file to be replicated is uploaded onto controller computer CC12 2335. The controller computer CC12 2335 controls where material is removed from block B9 2302 according to the uploaded data file by controlling movement of the cutting head 2355 and using manipulators 2348, 2349, and 2351 to manipulate the block B9 2302. The controller computer CC12 2335 uses control link 2333 to control movement of the cutting head 2355 on block B9 2302. Control signals are sent from the controller computer CC12 2335 by control link 2333 to the actuator AC25 2360. The actuator AC25 2360 controls movement of jointed arm 2350 to control the cutting head 2355 and remove material from block B9 2302. The cutting head 2355 may be a laser, a mechanical cutter or grinder, a thermal source, an ultrasound source, a solvent or other chemical, or some other mechanism to precisely remove material from block B9 2302. The controller computer CC12 2335 uses control link 2330 to control actuator AC23 2346 to manipulate the block B9 2302 using manipulator 2351. The controller computer CC12 2335 uses control link 2332 to control actuator AC24 2347 and manipulate block B9 2302 using manipulator 2349. The controller computer CC12 2335 uses control link 2331 to control actuator AC22 2345 manipulating block B9 2302 using manipulator 2348. Although three manipulators are shown, more or fewer are possible. As block B9 2302 material is removed, the exhaust 2370 removes any particulates, gases, or vapors produced. The cutting head 2355 gradually removes material from block B9 2302 until the 3-dimensional image is finished being replicated.

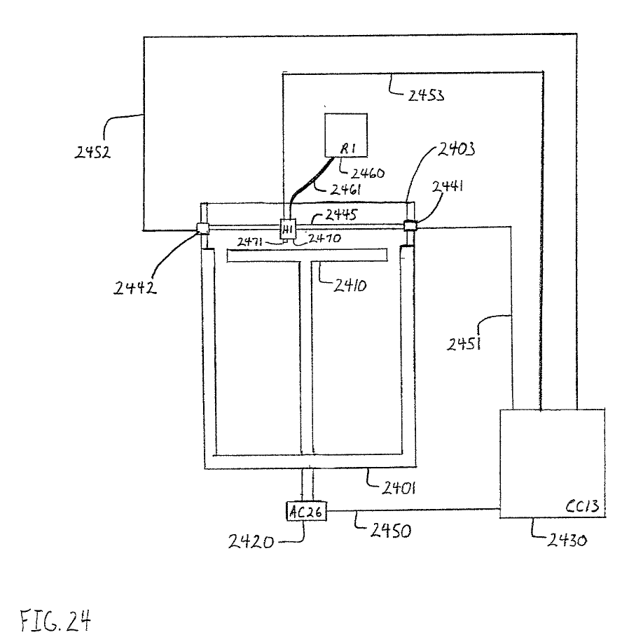

Another embodiment for building a 3-dimensional image is shown in FIG. 24. A build chamber 2401 has a support structure 2403 attached to its top. Extending up from the bottom of the build chamber 2401 is an elevated platform 2410. The elevated platform 2410 is attached to an actuator AC26 2420. A control link 2450 connects the actuator AC26 2420 to a controller computer CC13 2430. An x-axis router 2441 is attached to the support structure 2403. A y-axis router 2442 is attached to the support structure 2403. A guide track 2445 is attached to the x-axis router 2441 and the y-axis router 2442. An extruding head Hi 2470 rides on the guide track 2445. The extruding head Hi 2470 is connected by a flexible feed line 2461 to a reservoir R1 2460. The extruding head H1 2470 also has a nozzle 2471. A controller computer CC13 2430 is connected to the extruding head H1 2470 by control link 2453. The controller computer CC13 2430 is also connected to the x-axis router by control link 2451. Controller computer CC13 2430 is also connected to the y-axis router 2442 by control link 2452.

The controller computer CC13 2430 has a 3-dimensional data set uploaded to duplicate. The elevated platform 2410 is positioned so that the extruding head H1 2470 can deposit the corresponding layer of the object being replicated. The controller computer CC13 2430 uses control link 2451 to control movement of the extruding head H1 2470 on the x-axis on the guide track 2445 using the x-axis router 2441. The controller computer 2440 uses control link 2452 to control movement of guide track 2445 on the y-axis by the y-axis router 2442. Using the x-axis router 2441 and the y-axis router 2442, the extruding head H1 2470 can be controlled to trace out a layer of the 3-dimensional image data along the x and y axis.

The extruding head Hi 2470 has a nozzle 2471 that extrudes or sprays a material that can be used layer-by-layer to build a 3-dimensional object. The controller computer CC13 2430 can control the spray by control link 2453 to the extruding head H1 2470. A reservoir R1 2460 of material used to build the object is attached to the extruding head H1 2470 by a flexible feed line 2461 and provides material to the nozzle 2471. The nozzle 2471 may be heated, and the material sprayed may be melted wax, plastic, nylon or some other heat sensitive material. The material could also be some type of fast drying liquid, resin compound, aggregate compound such as liquid-clay or liquid-plaster or composite compound that quickly sets into a solid.

The controller computer CC13 2430 will control the movement and spray from the extruding head H1 2470 to build a layer of the object. Then the controller computer CC13 2430 will send a signal to actuator AC26 2420 by control link 2430 to lower the elevated platform 2410 by an amount equal to the thickness of a 3-dimensional data slice to be replicated. Then the next layer of the object is deposited. This process continues until the object is finished being replicated.

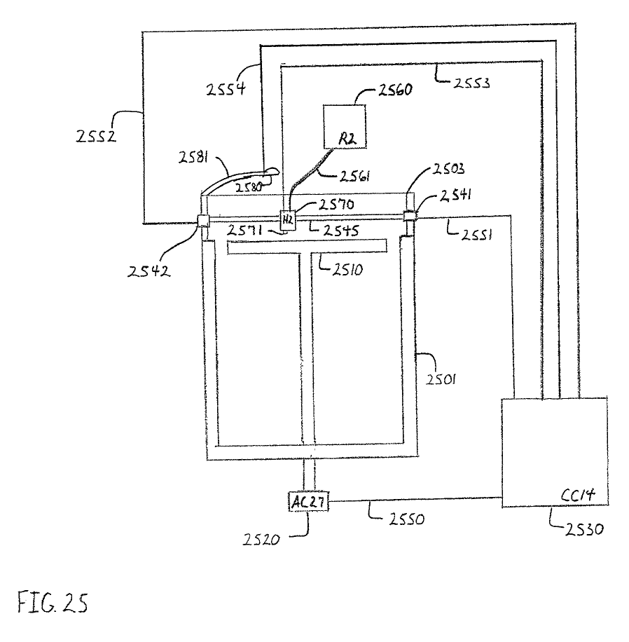

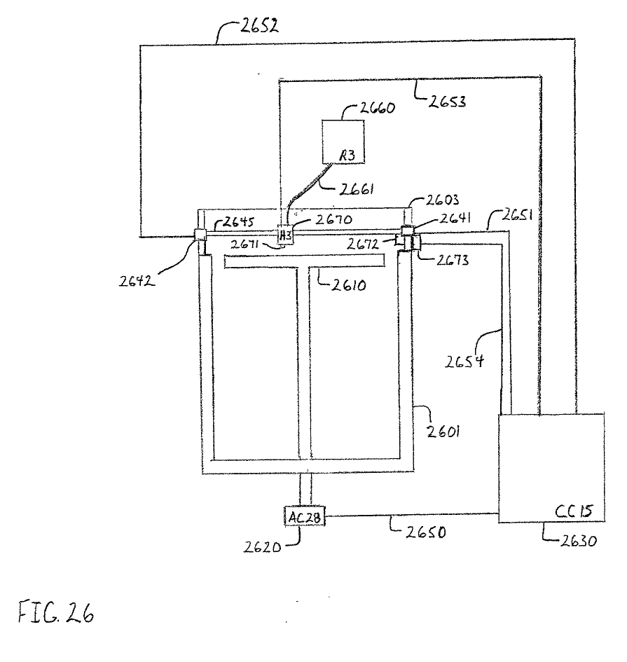

FIG. 25 shows another embodiment for building a 3-dimensional image based on fused deposition modeling. A build chamber 2501 has a support structure 2503 attached to its top. Extending up from the bottom of the build chamber 2501 is an elevated platform 2510. The elevated platform 2510 is connected to actuator AC27 2520. A control link 2550 connects the actuator AC27 2520 to a controller computer CC14 2530. An x-axis router 2541 is attached to the support structure 2503. A y-axis router 2542 is attached to support structure 2503. A guide track 2545 is attached to the x-axis router 2541 and the y-axis router 2542. An extruding head H2 2570 rides on the guide track 2545. The extruding head H2 2570 is attached by a flexible feed line 2561 to a reservoir R2 2560 of material used to build the object. The extruding head H2 2570 also has a nozzle 2571. The support bracket 2581 on top of the build chamber 2501 is either part of support structure 2503 or mounted to it. A UV light source 2580 is mounted on the bracket 2581.

The controller computer CC14 2530 is connected to the extruding head H2 2570 by control link 2553. The controller computer CC14 2530 is connected to the x-axis router 2541 by control link 2551. The controller computer CC14 2530 is connected to the y-axis router 2542 by control link 2552. The controller computer CC14 2530 is connected to the UV light source 2580 by control link 2554. The controller computer CC14 2530 is connected to the extruding head H2 2570 by control link 2553.

The controller computer CC14 2530 has a 3-dimensional data set uploaded to replicate. To replicate the first layer, the elevator platform 2510 is positioned at the top, so that the extruding head H2 2570 can deposit the first layer of the object being replicated. The controller computer CC14 2530 uses control link 2551 to control movement of the extruding head H2 2570 on the x-axis by the guide track 2545 using the x-axis router 2541. The controller computer CC14 2530 uses control link 2552 to control movement of the guide track 2545 on the y-axis by the y-axis router 2542. Using the x-axis router 2541 and the y-axis router 2542, the extruding head H2 2570 can be controlled to trace out the layers of the 3-dimensional image along the x and y axis.

The extruding head H2 2570 has a nozzle 2571 that sprays a material used layer-by-layer to build an object. The controller computer CC14 2530 can control the spraying by control link 2553 to the extruding head H2 2570. A reservoir 2560 of material used to build the object is attached to the extruding head by a flexible feed line 2561 and provides material to the nozzle 2571.

In this embodiment, the build material is a UV sensitive resin, composite, aggregate, or some other mixture that will completely cure or solidify when exposed to UV light. After spraying the layer, the controller computer CC14 2530 will activate the UV light source 2580 to cure or set the layer using control link 2554. The controller computer CC14 2530 will control the movement and spraying of the extruding head H2 2570 to build a layer of the object. Then the controller computer CC14 2530 will send an activation signal by control link 2554 to UV light source 2580 to turn on and instantly solidify the layer. After the layer is solidified, the controller computer will send a signal to actuator AC27 2520 by control link 2550 to lower the elevator platform 2510 by an amount equal to the thickness of the next 3-dimensional data slice. The next layer of the object is then deposited. This process continues until the object is finished being replicated.

FIG. 26 shows another alternative embodiment for building an object using fused deposition modeling with a heat source to bond the layers. A build chamber 2601 has a support structure 2603 attached to its top. Extending up from the bottom of the build chamber 2601 is an elevated platform 2610. The elevated platform 2610 is connected to an actuator AC28 2620. A control link 2650 connects actuator AC28 2620 to a controller computer CC15 2630. An x-axis router 2641 is attached to the support structure 2603. A y-axis router 2642 is attached to the support structure 2603. A guide track 2645 is attached to the x-axis router 2641 and the y-axis router 2642. An extruding head H3 2670 rides on the guide track 2645. The extruding head H3 2670 is attached to a flexible feed line 2661, which is attached to a reservoir R3 2660 of material used to build an object. The extruding head H3 2670 also has a nozzle 2671.

The controller computer CC15 2630 is connected to the extruding head H3 2670 by control link 2653. The controller computer CC15 2630 is connected to the x-axis router 2641 by control link 2651. The controller computer CC15 2630 is connected to the y-axis router 2642 by control link 2652. A thermal source actuator 2673 is also secured to support structure 2603. The thermal source actuator 2673 supports and moves a thermal source 2672. The thermal source actuator 2673 is connected to the controller computer by control link 2654.

The controller computer CC15 2630 has a 3-dimensional data set uploaded to replicate into an object. The elevated platform 2610 is positioned so that the extruding head H3 2670 can deposit the corresponding layer of the object being replicated. The controller computer CC15 2630 uses control link 2651 to control movement of the extruding head H3 2670 on the x-axis by the guide track 2645 using x-axis router 2641. The controller computer CC15 2630 uses control link 2652 to control movement of the guide track 2645 on the y-axis by the y-axis router 2642. Using the x-axis router 2641 and the y-axis router 2642, the extruding head H3 2670 can be controlled by controller computer CC15 2630 to trace out a layer of the 3-dimensional image along the x and y axis.

The extruding head H3 2670 has a nozzle 2671 that sprays a thermal sensitive material used layer-by-layer to build an object. The controller computer CC15 2630 can control the spraying by control link 2653 to the extruding head H3 2670. A reservoir R3 2660 of material used to build the object is fed to the extruding head H3 2670 by a flexible feed line 2661.

After spraying the layer, the controller computer CC15 2630 sends a command to thermal source actuator 2673. This causes a thermal source 2672 running the length of the build chamber 2601 to activate and move across the freshly deposited layer. This layer of material is a thermal sensitive material that melts or bonds together as heat is applied. Possible materials include resin powder mixtures, (e.g. powdered metal, ceramic powder, etc.), thermal sensitive resin, or composites.

The controller computer CC15 2630 will control the movement and spraying of the extruding head H3 2670 to trace out and build a layer of the object. Then the controller computer CC15 2630 will send a signal to actuator AC28 2620 by control link 2650 to lower the elevator platform 2610 by an amount equal to the thickness of the data slice being replicated. Then the next layer of the object can be deposited. This process continues until the object is finished being replicated.

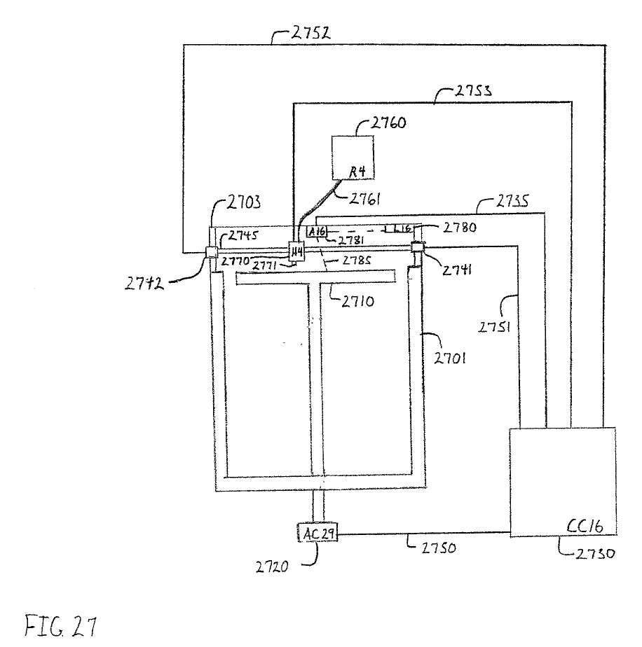

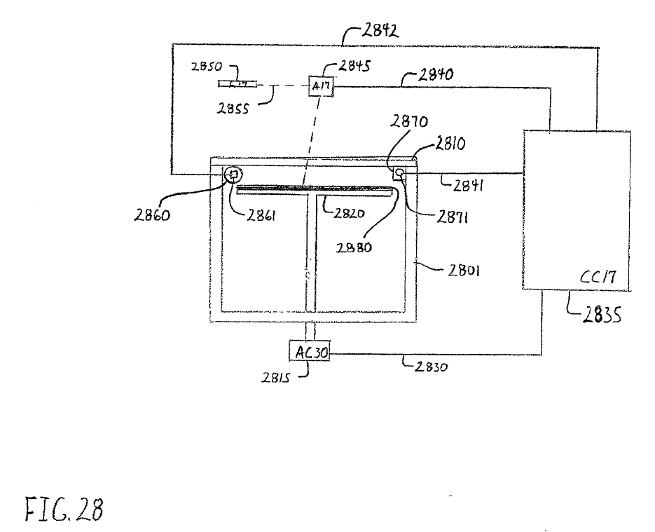

FIG. 27 shows another alternative embodiment for fused deposition modeling using a laser. A build chamber 2701 has a support structure 2703 attached to its top. Extending up from the bottom of the build chamber 2701 is an elevated platform 2710. The elevated platform 2710 is attached to an actuator AC29 2720. A control link 2750 connects the actuator AC29 2720 with a controller computer CC16 2730. An x-axis router 2741 is attached to the support structure 2703. A y-axis router 2742 is attached to the support structure 2703. A guide track 2745 is attached to the x-axis router 2741 and the y-axis router 2742. An extruding head H4 2770 rides on the guide track 2745. The extruding head H4 2770 is attached by a flexible feed line 2761 to a reservoir R4 2760 of material used to build an object. The extruding head H4 2770 also has a nozzle 2771. The controller computer CC16 2730 is connected to the extruding head H4 2770 by control link 2753. The controller computer CC16 2730 is connected to the x-axis router 2741 by control link 2751. The controller computer CC16 2730 is connected to the y-axis router 2742 by control link 2752. A laser L16 2780 is attached to support structure 2703. The laser L16 2780 emits a laser beam 2785 at aimer A16 2781 attached to the support structure 2703. A control link 2735 connects the aimer A16 2781 to the controller computer CC16 2730.

The controller computer CC16 2730 has a 3-dimensional data set uploaded to replicate as an object. The elevated platform 2710 is positioned so that the extruding head H4 2770 can deposit the corresponding layer of the object being replicated. The controller computer CC16 2730 uses control link 2751 to control movement of the extruding head H4 2770 on the x-axis by the guide track 2745 using the x-axis router 2741. The controller computer CC16 2730 uses control link 2752 to control movement of the guide track 2745 on the y-axis by the y-axis router 2442. Using the x-axis router 2741 and the y-axis router 2742, the extruding head H4 2770 can be controlled to trace out a layer of the 3-dimensional image along the x and y axis.

The extruding head H4 2770 has a nozzle 2771 that sprays a light or thermal sensitive material that can be used layer-by-layer to build a 3-dimensional object. The controller computer CC16 2730 can control the spraying by control link 2753 to the extruding head H4 2770. A reservoir R4 2760 of material used to build the object is fed to the extruding head H4 2770 by a flexible feed line 2761.

As material is deposited by nozzle 2771, or after the entire layer is traced out, the controller computer CC16 2730 uses the laser beam 2785 to bond the layer to the one below. The laser aimer A16 2781 is controlled by the controller computer CC16 2730 using control link 2735. The laser L16 2780 emits a laser beam 2785 at the aimer A16 2781, which is controlled over control link 2735. The aimed laser beam 2785 causes deposited material to bond to any previous layers. This bonding may be by melting the material or causing a light sensitive chemical reaction. Examples of materials that may be used are resin, resin powder mixture, powdered metal, plastic, or nylon.

The controller computer CC16 2730 will control the movement and spraying of the extruding head H4 2770 to build a layer of the object and then bond the layer with the laser beam 2785. Then the controller computer CC16 2730 will send a signal to actuator AC29 2720 by control link 2750 to lower the elevated platform 2710 by the amount equal to the thickness of the 3-dimensional data slices being replicated. Then the next layer of the object is deposited. This process is continued until the object is finished being replicated.

An embodiment using a process known as selective laser sintering to build an object is shown in FIG. 28. A build cabinet 2801 covered by a protective window 2810 contains an elevator platform 2820. An actuator AC30 2815 is connected to and moves the elevator platform 2820 inside the build cabinet 2801. The actuator AC30 2815 is connected to a controller computer CC17 2835 by control link 2830. At the top of the build cabinet 2801, at approximately the same level as the elevator platform 2820, there is a powder application cylinder 2860. The cylinder 2860 is attached to an actuator 2861. The powder application cylinder 2860 will deposit a layer of powder 2880 where it passes over the top of the elevator 2820 or the top of a previously built layer. The actuator 2861 is connected to controller computer CC17 2835 by control link 2842. Opposite from the powder application cylinder 2860, there is a powder cleaner mechanism 2870. The cleaner mechanism 2870 is attached to an actuator 2871. The actuator 2871 for the cleaner mechanism 2870 is connected to controller computer CC17 2835 by control link 2841. A laser L17 2850 located above protective window 2810 emits a laser beam 2855. The laser beam 2855 is aimed by an aimer A17 2845, and the aimer A17 2845 is aimed by the controller computer CC17 2835 using control link 2840.

The 3-dimensional data file to be replicated is uploaded onto the controller computer CC17 2835. The elevated platform 2820 is positioned so that a layer of powder equal to the thickness of the layer from the slice of the 3-dimensional data to be replicated can be applied by the powder application cylinder 2860.

The controller computer CC17 2835 commands the powder application cylinder 2860 to roll across the surface of the elevator platform 2820 or a previous built layer by activating actuator 2861 using control link 2842. This deposits a layer of powder 2880. After the powder layer 2880 is deposited, the controller computer CC17 2835 uses control link 2840 to trace out the layer of the 3-dimensional image being replicated on the powder layer 2880 using laser beam 2855 aimed by aimer A17 2845. Wherever the laser beam 2855 hits the powder layer 2880, the layer 2880 melts and fuses to form a layer of the 3-dimensional image. After the controller computer CC17 2835 finishes tracing out the 3-dimensional image layer, the controller computer CC17 2835 activates the cleaner mechanism 2870 by control link 2841 to the actuator 2871. The cleaner mechanism 2870 may be an air-blower or vacuum or some other mechanical device, and this mechanism removes the unfused powder.

Once the layer is finished, the controller computer CC17 2835 sends a control signal over control link 2830 to the actuator AC30 2815 to lower the elevator platform 2820 by an amount equal to the data's thickness for the next layer. The process is repeated until the object from the 3-dimensional image data is completely replicated.

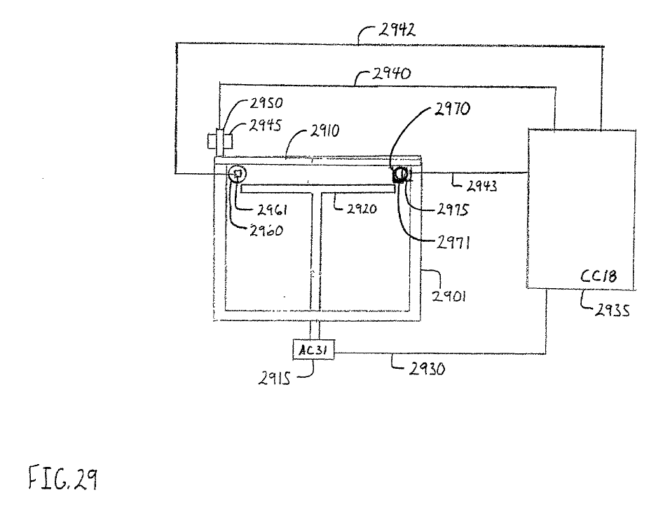

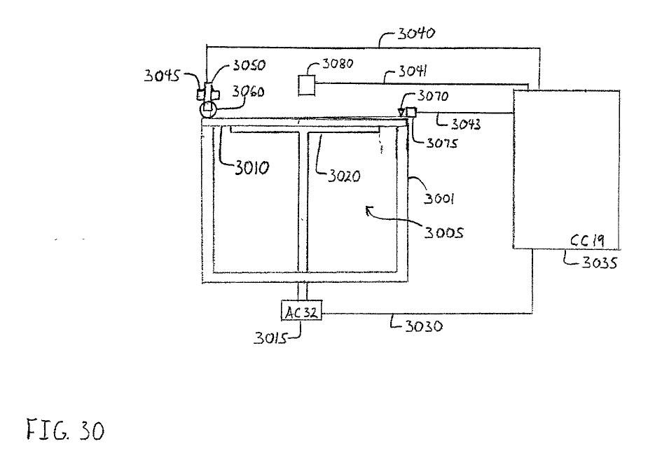

Another embodiment for replicating a 3-dimensional data set is shown in FIG. 29. FIG. 29 shows a build cabinet 2901 covered by a protective window 2910 containing elevator platform 2920. An actuator AC31 2915 is connected to and moves the elevator platform 2920 inside the build cabinet 2901. The actuator AC31 2915 is connected to a controller computer CC18 2935 by control link 2930. The controller computer CC18 2935 is connected to an image transfer array 2945 by control link 2940. The array 2945 is mounted to an array support actuator 2950, which also receives command inputs over control link 2940. Inside the build cabinet 2901, at the top under the protective window 2910, there is an image transfer cylinder 2960 mounted on an image transfer actuator 2961. A control link 2942 connects the image transfer actuator 2961 to the controller computer CC118 2935. Opposite the image transfer actuator 2961 there is an image binding actuator 2971, which is connected to the controller computer CC18 2935 by control link 2943. Mounted on actuator 2971 is an electrostatic sensitive substrate roller 2970 and a binder source 2975.

A 3-dimensional data file to be replicated is uploaded onto the controller computer CC18 2935. The elevator platform 2920 is positioned so that a layer of electrostatic sensitive substrate equal to the thickness of the layer from the slice data of the image being replicated can be applied by the electrostatic sensitive substrate roller 2970. The controller computer CC18 2935 begins building an object by sending image data by control link 2940 to the image transfer array 2945. At the same time, the controller computer CC18 2935 sends a command over control link 2940 to the image transfer actuator 2950 that causes the actuator 2950 to move the array 2945 across the surface of protective window 2910. The image transfer actuator 2961 is controlled by control link 2942, and it moves the image transfer cylinder 2960 at the same rate as the image transfer array 2945 across the surface of the elevator platform 2920. The image transfer array 2945 transfers an image of charged area to the image transfer cylinder 2960, which in turn charges the surface of the elevator platform 2920 or a previous applied layer with an electrostatic charge as it rolls over the surface.

After the image transfer cylinder 2960 finishes transferring the image of the layer as a tracing of charged surface, the controller computer CC18 2935 activates the image binder and actuator 2971, which causes the electrostatic sensitive substrate roller 2970 and the binder source 2975 to pass over the surface. The electrostatic substrate may be a powder, a resin, or some other type of compound that the binder source 2975 can bind together and is attracted by an electrostatic charge. As the electrostatic sensitive substrate roller 2970 passes over the platform 2920, it deposits a layer of electrostatic sensitive substrate to the charged areas. The binder 2975 causes the deposited substrate to bind together, forming the layer of the 3-dimensional image. After the object layer is deposited and bonded, the controller computer CC18 2935 sends a control signal over control link 2930 to actuator AC31 2915 to lower the elevator platform 2920 by an amount equal to the next thickness to be replicated. This process repeats until a 3-dimensional image is finished being replicated.

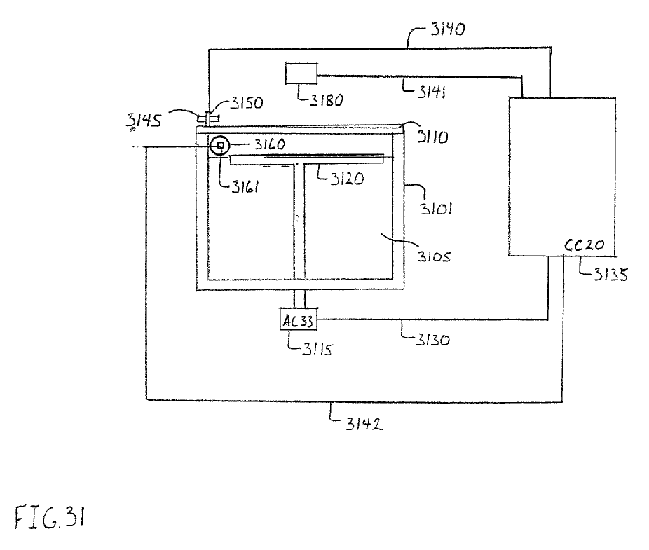

In the 3-dimensional imaging technology embodiment of FIG. 30 for replicating a 3-dimensional data file, a reaction vat 3001 contains UV sensitive resin 3005 covered with a protective window 3010. The reaction vat 3001 contains an elevator platform 3020, which is connected to an actuator AC32 3015. The actuator AC32 3015 is connected to a controller computer CC19 3035 by control link 3030. A controller computer CC19 3035 is linked to an image transfer mechanism 3050 by control link 3041. An image transfer array 3045 and an image transfer cylinder 3060 are mounted to the image transfer mechanism 3050. The controller computer CC19 3035 is also connected to an image cleaning actuator 3075, which has an image cleaning mechanism 3070 attached, by control link 3043. There is a UV light source 3080 (e.g. a UV flash) positioned over the protective window 3010, which is connected to the controller computer CC19 3035 by control link 3041.

The 3-dimensional data set to be replicated is uploaded onto the controller computer CC19 3035. The elevator platform 3020 is positioned so that a layer of UV sensitive resin 3005 of equal thickness to the thickness of the 3-dimensional data file slice of the layer being duplicated covers the surface of elevator platform 3020. The controller computer CC19 3035 transmits the image layer to be replicated by control link 3040 to the image transfer mechanism 3050. The image array 3045 receives the image data and transfers the image to the image transfer cylinder 3060. A control signal on control link 3040 will also start the image transfer mechanism 3050 moving across protective window 3010. As this happens, the image transfer cylinder 3060 rolls across protective window 3010. The image transfer cylinder 3060 deposits a layer of particles on the protective window 3010, so that the areas corresponding to the layer being replicated are left clean. This creates an “image” of clean glass on the protective window 3010 of the image layer being replicated. After the image layer is deposited onto the protective window 3010, the controller computer 3015 sends a command by control link 3041 to activate UV light 3080. UV light shines through the clean area of the protective window 3010 to strike the UV sensitive resin 3005. This UV light solidifies the resin 3005, forming the layer of the 3-dimensional image. The controller computer CC19 3035 then sends a control signal over control link 3040 to the image-cleaning actuator 3075. This causes the image-cleaning actuator 3075 to activate and move the image cleaner mechanism 3070 across protective window 3010, cleaning the image off. At the same time, the controller computer CC19 3035 uses control link 3030 to signal actuator AC32 3015 to lower the elevator platform an amount equal to the thickness for the next layer. Fresh resin 3005 flows over the layer. Then the process is repeated until the 3-dimensional image is completely replicated.

Another possible embodiment for 3-dimensional image replication is shown in FIG. 31. A reaction vat 3101 contains resin 3105 that becomes sensitive to a curing agent (e.g. heat, UV light, etc.) when electrostatically charged. The reaction vat 3101 is covered by protective window 3110. The reaction vat 3101 contains an elevator platform 3120, which is connected to and moved by an actuator AC33 3115. The actuator AC33 3115 is connected to a controller computer CC20 3135 by control link 3130. The controller computer CC20 3135 is linked to an image transfer mechanism 3150 by control link 3140, which is connected to and controls an image transfer array 3145 that is also linked to controller computer 3133 by control link 3142. The image transfer array 3145 is mounted to the image transfer mechanism 3150. The controller computer CC20 3135 is also connected to an image transfer actuator 3161, which has an image transfer cylinder 3160 mounted, by control link 3142. The image transfer actuator 3161 and image transfer cylinder 3160 are located under the protective window 3110 and above the surface of the resin 3105. There is a curing source 3180 (e.g. a UV flash, heat source, etc.) positioned above the protective window 3110, which is connected to the controller computer CC20 3135 by a control link 3141.

The 3-dimensional data file to be replicated is uploaded onto the controller computer CC20 3135. The elevator platform 3120 is positioned so that the image transfer cylinder 3160 will roll over the surface of the platform 3120 or a previously built layer. The controller computer CC20 3135 transmits the image of the layer to be replicated by control link 3140 to the image transfer array 3145. The image array 3145 receives the image and transfers the image to the image transfer cylinder 3160 as the image transfer mechanism moves across the elevator platform 3120 or a previously built layer. The controller computer CC20 3135 also activates the image transfer actuator 3150, which begins moving the image transfer array 3145 across the surface of the protective window 3110. The controller computer CC20 3135, using control link 3142, also causes the image transfer actuator 3161 to begin moving the image transfer cylinder 3160 across the surface of the elevator platform 3120 or a previous layer. As image transfer cylinder 3160 rolls across the platform 3120 or a layer, it charges the surface with a charge corresponding to the image of the layer being replicated. This creates an image of electrostatic charge on the platform 3120 or a previous built layer corresponding to the layer being replicated. After the surface is charged, the controller computer CC20 3135 sends a command by control link 3130 to the actuator AC33 3115 to lower the elevator platform 3120 by an amount equal to the data thickness for the layer being replicated. Fresh resin 3105 flows over the platform 3120 covering the charged area, which makes the resin sensitive to the curing source 3180. A control signal is then sent by the controller computer CC20 3135 activating the curing source 3180. The curing source 3180 causes a reaction with the electrostatic sensitive resin 3105 covering the charged area and solidifies the resin forming that layer of the 3-dimensional image. This process repeats until the 3-dimensional image is completely replicated.

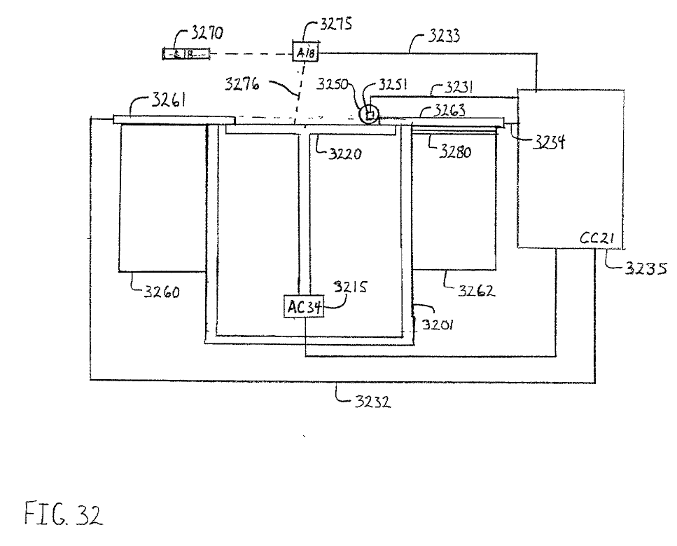

Another embodiment for building a 3-dimensional image is shown in FIG. 32. A build cabinet 3201 contains an elevator platform 3220 connected to an actuator AC34 3215. The actuator AC34 3215 is connected to a controller computer CC21 3235 by control link 3230. The controller computer CC21 3235 is connected to a hot roller actuator 3251 by control link 3231. The actuator 3251 supports and controls a hot roller 3250 located above the elevator platform 3220. The controller computer CC21 3235 is linked to a used sheet remover 3261 by control link 3232. The used sheet feeder 3261 is mounted on top of a used sheet storage cassette 3260. The used sheet feeder 3261 and used sheet storage cassette 3260 are mounted to the build cabinet 3201. A new sheet feeder 3263 is mounted on top of a new sheet storage cassette 3262, which contains laminate sheets 3280. The new sheet feeder 3263 and new sheet cassette 3262 are mounted to the build cabinet 3201. A control link 3234 links the new sheet feeder 3263 to the controller computer CC21 3235. The controller computer CC21 3235 is connected to a laser aimer A18 3275 by control link 3233. A laser L18 3270 emits a laser beam 3276 toward the aimer A18 3275 and is aimed by aimer A18 3275.

The 3-dimensional image to be replicated is uploaded onto the controller computer CC21 3235. The new sheet cassette 3262 contains laminate sheets 3280. The controller computer CC21 3235 commands a laminate sheet 3280 to be fed from the new sheet cassette 3262 over the elevated platform 3220 using control link 3234 to the new sheet feeder 3263. The controller computer CC21 3235 uses control link 3233 to control aimer A18 3275. The laser L18 3270 emits a laser beam 3276 aimed by aimer A18 3275 to cut out the layer of the 3-dimensional image being replicated from the laminate sheet 3280 positioned over the platform 3220. The controller computer CC21 3235 then sends a command to the roller actuator 3251 over control link 3231. This causes the hot roller 3250 to roll over the surface of the laminate sheet 3280 that has been cut out by the laser beam 3276. The roller applies heat and pressure to bond or laminate layers of the laminate sheet 3280 to each other.

After the hot roller 3250 finishes the bonding or lamination of the layer, the controller computer CC21 3235 sends a command to the actuator AC34 3215 to lower the elevator platform by an amount equal to the thickness of the sheet of laminate material 3280. The data slices that are replicated are the same thickness as the laminate sheet 3280. Lowering the elevator platform 3220 separates the laminate section that was cut by the laser beam 3276 from the other part. The controller computer CC21 3235 then sends a control signal to the used sheet remover 3261. The used sheet remover 3261 removes the used laminate sheet 3280 remaining (with the traced data layer removed). The used sheet is fed into the used sheet cassette 3260. A new sheet 3280 is then fed from the new sheet cassette 3262, and the process of cutting laminate layers and laminating them together with the hot roller 3250 continues until the 3-dimensional image is finished being replicated. This method of replicating a 3-dimensional image is referred to as layered or laminated object modeling. The laminate material can be impregnated paper, ceramic powder strips, metal powder strips, polystyrene sheets, plastic sheets, or composite sheets.

These various methods of 3-dimensional imaging can be used to replicate 3-dimensional data images with great precision and relative ease compared to previous methods. These methods have been utilized in industrial, engineering, and manufacturing settings to significantly reduce the time and expense of producing molds, prototype parts, and other objects in industry and engineering and development settings. Items that took weeks to produce at great expense can be built in days at far lesser expense.

The Business Method

The invention includes a method of capturing, manufacturing, and delivering a custom made 3-dimensional art object to a consumer. The goal of the invention is to provide such service to produce good quality art objects such as busts, sculptures, bas-reliefs, and cameos for pictures or jewelry, in much the same fashion as a photography studio.

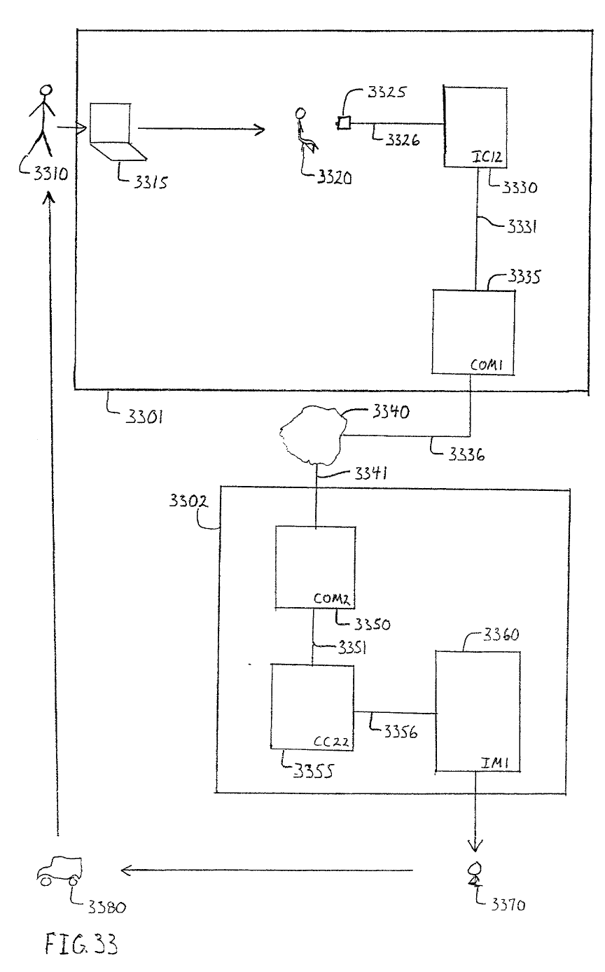

FIG. 33 sets forth one preferred embodiment of the invention. There is a consumer 3310 and a studio 3301. The studio 3301 contains a cash register or other payment method 3315, a 3-dimensional image capture system consisting of a camera set-up 3325 connected by a cable 3326 to an image processing computer IC12 3330. The object to be reproduced is object 3320. There is a communication link 3331 to a communication computer COM1 3335, which is also in the studio 3301. There is a communication link 3336 from the communication computer COM1 3335 to the Internet 3340 and a communication link 3341 from the Internet 3340 to a communication computer COM2 3350. A controller computer CC22 3355 is connected to the communication computer COM2 3350 by communication link 3351. The controller computer CC22 3355 is connected to a 3-dimensional imaging machine IM1 3360 by control link 3356. A manufacturing facility 3302 contains the communication computer COM2 3350, the controller computer CC22 3355, and the 3-dimensional imaging machine IMI 3360. The output of the 3-dimensional imaging machine IM1 3360 is object 3370, the art object, and it is given to a shipping service 3380 for final delivery to consumer 3310.

Although only a single camera system is shown in the studio, it is readily apparent as an alternative embodiment that several camera systems such as described in FIGS. 1-11 could be used in a studio. Similarily, there could be several cameras linked to an image processing computer. Several 3-dimensional imaging machines may also be located in a manufacturing facility, and a single controller computer may control several 3-dimensional imaging machines.

The consumer 3310 enters the studio 3301. The consumer 3310 orders an art object and makes a payment at the cash register 3315. The consumer furnishes an object 3320 to reproduce as the ordered art object. This object could be a person, animal, or thing. A camera set up 3325 captures a 3-dimensional image of object 3320. This camera set up 3325 can be one of the previous described embodiments for capturing a 3-dimensional image or some other similar embodiment. The image data from this camera set up 3325 is transferred to an image-processing computerIM12 3330 by communication link 3326. The image is processed and converted into a compatible file format for use by a 3-dimensional imaging machine. During the image-processing phase, the image is edited to the size and visual quality desired by the consumer. After the image is approved by the consumer and finalized, it is stored digitally on the computer or on some other data storage medium such as a compact disk. This stored data can be used to create a 3-dimensional photographic image and is available for potential reorder or additional adjustments. The finalized data is then transferred by communication link 3331 to a communication computer COM1 3335. The communication link 3331 can be a wired link, but the data transfer could be by computer disk or some other data storage transfer device generated by the image-processing computer IC12 3330 to transfer data to the communication computer COM1 3335.

The communication computer COM1 3335 is used to establish link 3336 to the Internet 3340. Data sent to communication computer COM2 3350 is routed from the Internet 3340 by communication link 3341 to communication computer COM2 3350 at the manufacturing facility 3302 based on the address in the data file. The Internet 3340 establishes communication link 3341 using the address in the data file. The data file from communication computer COM1 3335 is transmitted along this communication link (link 3336 to Internet 3350 and then along link 3341) to the communication computer COM2 3350. The data file is transferred from communication computer COM2 3350 by communication link 3351 to the controller computer CC22 3355 that will control the 3-dimensional imaging machine IM1 3360 and replicate the data file. This communication link 3351 can be a direct wired link, but this transfer could be by computer disk or some other data transfer device generated by the communication computer COM2 3350.

Once the controller computer CC22 3355 receives the data file to replicate, the controller computer CC22 3355 controls a 3-dimensional imaging machine IM1 3360 to build the 3-dimensional image layer-by-layer using command link 3356. The 3-dimensional imaging machine kisM 3360 can be one of the previous described embodiments to produce a 3-dimensional object or some other similar embodiment. The 3-dimensional imaging machine IM1 3360 produces an object 3370. This object may be the final art object 3370 ordered by the consumer 3310. However, the object 3370 may require further processing.

The object 3370 may require additional processing into the ordered art object. The object 3370 may need to be dipped or sprayed with a preservative or stiffening coating. The object 3370 may need to be dried at room temperature or in a low temperature high air-flow velocity oven to harden the material. The object 3370 may need other finishing steps such as polishing, glazing, or plating. The object 3370 may be a molding for a cast or used as a pattern for a casting mold (e.g. green sand or lost wax method) to produce a metal figure in bronze, aluminum, pewter, silver or some other metal or compound. Before being delivered, the object 3370 may also be hand or spray-painted, either to add color or as a protective, preservative finish. After the art object 3370 is completed, a shipping service 3380 (e.g. UPS, Federal Express, U.S. Postal Service, etc.) is utilized to deliver the art object 3370 to the consumer 3310. As an alternative embodiment, the object produced by the 3-dimensional imaging machine 3260 may be delivered to the studio 3301 for finishing as the art object. As another alternative embodiment, the art object may be delivered to a third person (e.g. a gift).

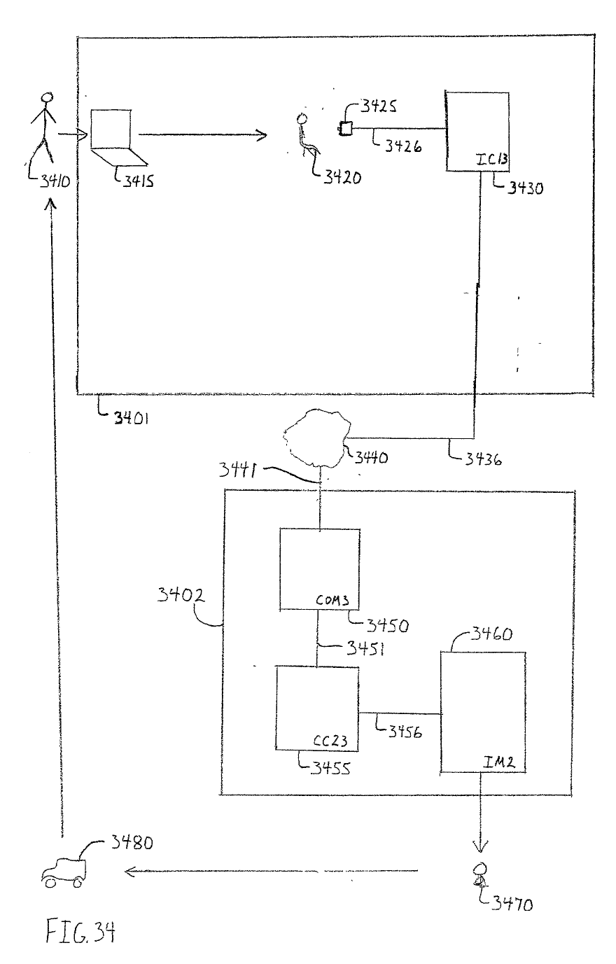

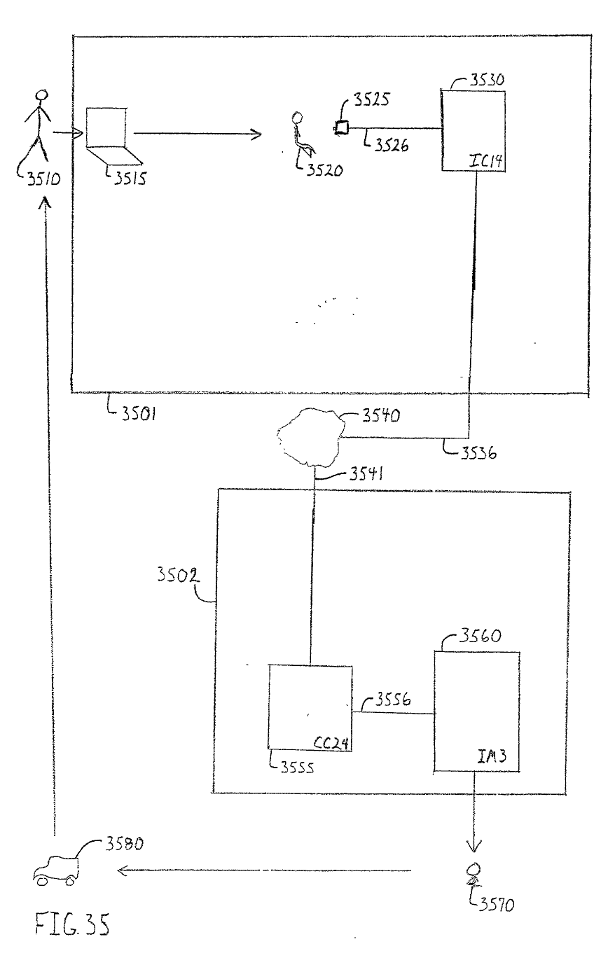

Another alternative embodiment is found in FIG. 34. There is a consumer 3410 and a studio 3401. The studio 3401 contains a cash register or other payment method 3415 and a 3-dimensional image capture system consisting of a camera set up 3425 connected by a cable 3426 to an image-processing computer IC13 3430. The object to be reproduced is object 3420. There is a communication link 3436 from the image-processing computer IC13 3430 directly to the Internet 3440 and a communication link 3441 from the Internet 3440 to a communication computer COM3 3450. The controller computer CC23 3455 is connected to the communication computer COM3 3450 by communication link 3451, and the controller computer CC23 3455 is connected to a 3-dimensional imaging machine IM2 3460 by control link 3456. A manufacturing facility 3402 contains the communication computer COM3 3450, the controller computer CC23 3455, and the 3-dimensional imaging machine IM2 3460. The output of the 3-dimensional imaging machine IM2 3460 is an object 3470, the art object, and it is given to a shipping service 3480 for final delivery to the consumer 3410.

The consumer 3410 enters the studio 3401. The consumer 3410 orders an art object and makes a payment at the cash register 3415. The consumer furnishes an object 3420 to reproduce as the ordered art object. A camera set up 3425 captures a 3-dimensional image of object 3420. The camera set up 3425 may be one of the previously described embodiments for capturing a 3-dimensional image or some other similar embodiment. The image data from camera set up 3425 is transferred to an image-processing computer IC13 3430 by communication link 3426. The image is processed, finalized, and converted into a compatible file format for use by a 3-dimensional imaging machine. After the image is approved by the consumer and finalized, it is stored on the computer or on some other data storage medium such as a compact disk. This stored data can be used to create a 3-dimensional photographic image and is available for potential reorder or additional adjustments. The data is transmitted by a communication link 3436 established by the image-processing computer IC13 3430 to the Internet 3440. The Internet 3440 is connected to the communication computer COM3 3450 at the manufacturing facility 3402 by communication link 3441. The data file to be replicated is transmitted from the image-processing computer IC13 3430 addressed to communication computer COM3 3450. The Internet 3440 uses the address to establish the communication link 3441 to communication computer COM3 3450 and transmit the data. The data file is then transmitted by communication link 3451 to the controller computer CC23 3455 that will control the 3-dimensional imaging machine IM2 3460 to replicate the data file. This communication link 3451 can be a direct wired link, but the transfer could be by computer disk or some other data transfer device generated by communication computer COM3 3450.

Once the controller computer CC23 3455 receives the data file to be replicated, the controller computer CC23 3455 controls a 3-dimensional imaging machine IM2 3460 to build the 3-dimensional image using control link 3456. The 3-dimensional imaging machine IM2 3460 can be one of the previous described embodiments for producing an object or some other similar embodiment. The 3-dimensional imaging machine IM2 3460 produces an object 3470. This object 3470 may be the final art object ordered by the consumer 3410. However, the object 3470 may require further processing.

The object 3470 may require additional processing into the ordered art object. The object 3470 may need to be dipped or sprayed with a preservative or stiffening coating. The object 3470 may need to be dried at room temperature or in a low temperature high air-flow velocity oven to harden the material. The object 3470 may need other finishing steps such as polishing, glazing, or plating. The object 3470 may be a molding for a cast or used as a pattern for a casting mold (e.g. green sand or lost wax method) to produce a metal figure in bronze, aluminum, pewter, silver or some other metal or compound. Before being delivered, the object 3470 may also be hand or spray-painted, either to add color or as a protective, preservative finish. Once the art object is complete, a shipping service 3480 (e.g. UPS, Federal express, U.S. Postal Service, etc.) is then utilized to deliver the art object 3470 to the consumer 3410.

Another embodiment for the business method is found in FIG. 35. There is a consumer 3510 and a studio 3501 shown. The studio 3501 contains a cash register or other payment method 3515, a 3-dimensional image capturing system consisting of a camera set up 3525 connected by a communication link 3526 to an image-processing computer 3530. The object being replicated is object 3520. There is a communication link 3536 from the image-processing computer 3530 to the Internet 3540, and a communication link 3541 from the Internet 3540 to a controller computer 3555. A control link 3556 connects the controller computer 3555 to a 3-dimensional imaging machine 3560. The controller computer 3555 and the 3-dimensional imaging machine 3560 are located in a manufacturing facility 3502. The output of the 3-dimensional imaging machine 3560 is art object 3570. There is a shipping service 3580 that picks up art object 3570 for delivery to the consumer 3510.

The consumer 3510 enters the studio 3501. The consumer 3510 orders an art object and makes a payment at the cash register 3515. The consumer 3510 produces an object 3520 to reproduce as the ordered art object. A camera set up 3525 captures a 3-dimensional image of the object 3520. The camera set up 3525 can be one of the previous described 5embodiments for capturing 3-dimensional images or some other similar -embodiment. The image data from camera set up 3525 is transmitted to an image-processing computer IC14 3530 by communication link 3526. The image is processed and finalized into a compatible file format for use by a 3-dimensional imaging machine. During the image-processing, the image is edited to the desired size and visual quality desired by the consumer. After the image is approved by the consumer and finalized, it is stored digitally on the computer or some other data storage medium. This stored data can be used to create a 3-dimensional photographic image and is available for potential reorder or additional adjustments. The image-processing computer IC14 3530 is used to establish a communication link 3536 to the Internet 3540 and transmits the data over the communication link 3536 to the Internet 3540. The data is addressed to the controller computer CC24 3555, and the Internet 3540 establishes communication link 3541 to finish transmitting the file to the controller computer CC24 3555.

Once the controller computer CC24 3555 receives the data file to be replicated, the controller computer CC24 3555 controls the 3-dimensional imaging machine IM3 3560 over control link 3556 to replicate the 3-dimensional image. The 3-dimensional imaging machine IM3 3560 can be one of the previously described embodiments described in FIGS. 12-32 for replicating a 3-dimensional image file or some other similar embodiment. The reproduced 3570 object may be the final art object ordered by the consumer. However, the object 3570 produced by the 3-dimensional imaging machine IM3 3560 may require further processing and finishing.

The object 3570 may require additional processing into the ordered art object. The object 3570 may need to be dipped or sprayed with a preservative or stiffening coating. The object 3570 may need to be dried at room temperature or in a low temperature high air-flow velocity oven to harden the material. The object 3570 may need other finishing steps such as polishing, glazing, or plating. The object 3570 may be a molding for a cast or used as a pattern for a casting mold (e.g. green sand or lost wax method) to produce a metal figure in bronze, aluminum, pewter, silver or some other metal or compound. Before being delivered, the object 3570 may also be hand or spray-painted, either to add color or as a protective, preservative finish. After the art object 3570 is completed, a shipping service 3580 (e.g. UPS, Federal Express, U.S. Postal Service, etc.) is used to pick up and deliver the art object 3570 to the consumer 3510.

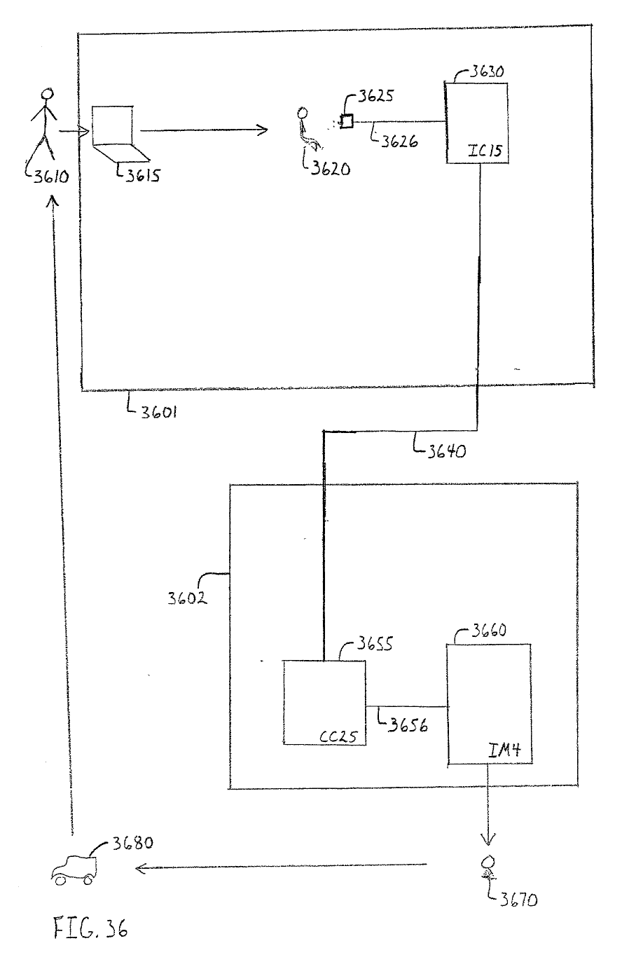

Another alternative embodiment is shown in FIG. 36 using a dedicated communication link between the studio and the manufacturing facility. A consumer 3610 and a studio 3601 is shown. The studio 3601 contains a cash register or other payment method 3615, a 3-dimensional image capturing system consisting of a camera set up 3625 connected by communication link 3626 to an image-processing computer IC15 3630. The object being replicated is object 3620. There is a communication link 3640 from the image-processing computer IC15 3630 to a controller computer CC25 3655 at a manufacturing facility 3602. A control link 3656 connects the controller computer CC25 3655 to a 3-dimensional imaging machine IM4 3660. The controller computer CC25 3655 and the 3-dimensional imaging machine IM4 3660 are located in the manufacturing facility 3602. The output of the 3-dimensional imaging machine IM4 3660 is art object 3670. There is a shipping service 3680 that picks up art object 3670 for delivery to consumer 3610.

The consumer 3610 enters the studio 3601. The consumer 3610 orders an art object and makes a payment at the cash register 3615. The consumer 3610 furnishes an object 3620 to reproduce as the ordered art object. A camera set up 3625 captures a 3-dimensional image of object 3620. The camera set up 3625 can be one of the previous described embodiments for capturing a 3-dimensional image or some other similar embodiment. The image data from camera set up 3625 is transmitted to an image-processing computer IC15 3630 by communication link 3626. The image is processed and finalized into a compatible file format for use by a 3-dimensional imaging machine. During the image-processing, the image is edited to the desired size and visual quality desired by the consumer. After the image is approved by the consumer and finalized, it is stored digitally on the computer or some other data storage medium. This stored data can be used to create a 3-dimensional photographic image and is available for potential reorder or additional adjustments. The image-processing computer IC15 3630 is connected by communication link 3640 to the controller computer CC25 3655 at the manufacturing facility 3602, and the image-processing computer IC15 3630 can transmit the data file directly to the controller computer 3660. The communication link 3640 can be a direct dedicated connection. An alternative embodiment is a telephone link established by the image-processing computer IC15 3630 and data transfer by a modem.

Once the controller computer CC25 3655 receives the data file to be replicated, the controller computer CC25 3655 controls the 3-dimensional imaging machine IM4 3660 over control link 3656 to replicate the object. The 3-dimensional imaging machine IM4 3660 can be one of the previous described embodiments for producing an object from a 3-dimensional data file or some other similar embodiment. The produced object 3670 may be the final art object ordered by the consumer 3610. However, the object produced by the 3-dimensional imaging machine IM4 3660 may require further processing and finishing.

The object 3670 may require additional processing into the ordered art object. The object 3670 may need to be dipped or sprayed with a preservative or stiffening coating. The object 3670 may need to be dried at room temperature or in a low temperature high air-flow velocity oven to harden the material. The object 3670 may need other finishing steps such as polishing, glazing, or plating. The object 3670 may be a molding for a cast or used as a pattern for a casting mold (e.g. green sand or lost wax method) to produce a metal figure in bronze, aluminum, pewter, silver or some other metal or compound. Before being delivered, the object 3670 may also be hand or spray-painted, either to add color or as a protective, preservative finish. After the art object 3670 is completed, a shipping service 3680 (e.g. UPS, Federal Express, U.S. Postal Service, etc.) is used to deliver the object 3670 to the consumer 3610.

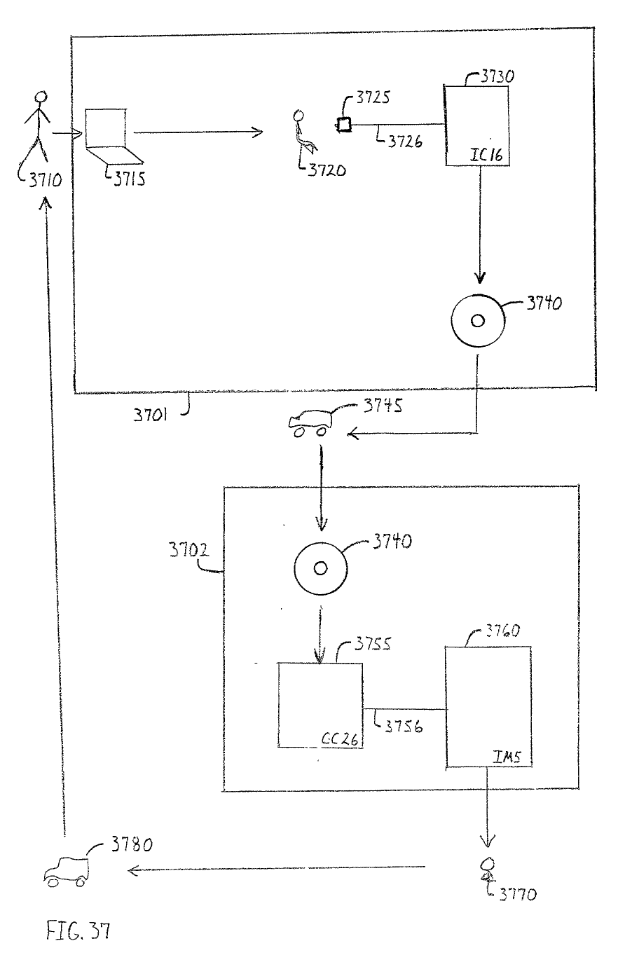

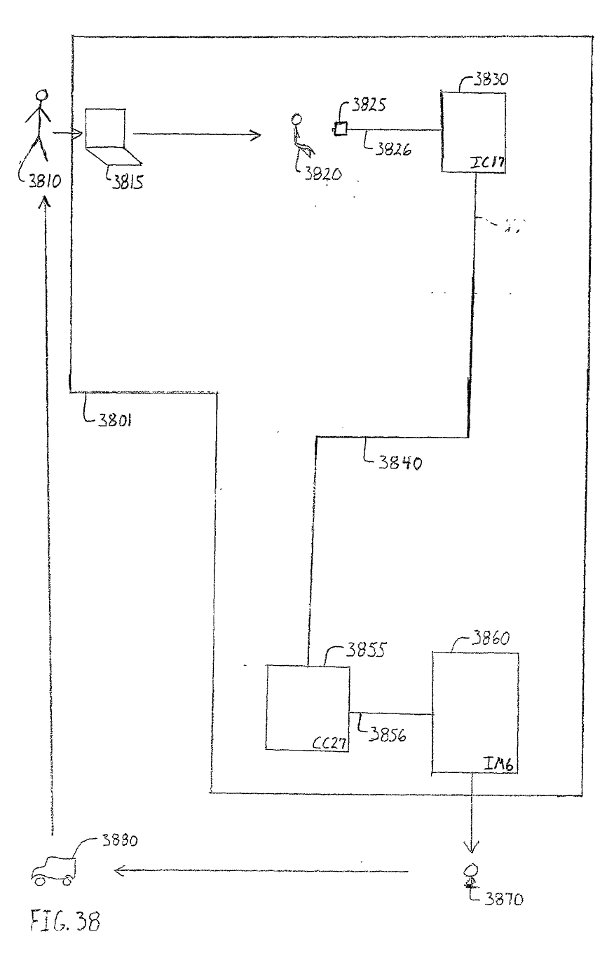

Data transfer over the Internet, phone lines, or dedicated communication link may not be practical or desirable. FIG. 37 shows an embodiment that does not use any direct communication link to transmit the data file from a studio to a manufacturing facility. In this embodiment, there is a consumer 3710 and a studio 3701. The studio 3701 contains a cash register or other payment method 3715, a 3-dimensional image capturing system consisting of a camera set up 3725 connected by a communication link 3726 to an image-processing computer IC16 3730. The object being duplicated is 3720. The output from the image-processing computer IC16 3730 is a data storage and transfer device 3740. There is a courier or shipping service 3735 that operates between studio 3701 and a manufacturing facility 3702. The manufacturing facility MF 3702 contains a controller computer CC26 3755 connected to a 3-dimensional imaging machine IM5 3760 by control link 3756. The output of the 3-dimensional imaging machine IM5 3760 is art object 3770. There is a shipping service 3780 (e.g. UPS, Federal Express, U.S. Postal Service, etc.) that picks up art object 3770 for delivery to consumer 3710.

The consumer 3710 enters the studio 3701. The consumer 3710 orders a art object and makes a payment at the cash register 3715. The consumer 3710 furnishes an object 3720 to reproduce as the ordered art object. A camera set up 3725 captures a 3-dimensional image of object 3720. The camera set up 3725 can be one of the previous described embodiments for capturing a 3-dimensional image or some other similar embodiment. The image data from camera set up 3725 is transmitted to an image-processing computer IC16 3730 by communication link 3726. The image-processing computer IC16 3730 processes and finalizes the data into a file format compatible with a 3-dimensional imaging machine. During the image-processing, the image is edited to the desired size and visual quality desired by the consumer. After the image is approved by the consumer and finalized, it is stored digitally on the computer or some other data storage medium. This stored data can be used to create a 3-dimensional photographic image and is available for potential reorder or additional adjustments. In this embodiment, the data file is saved onto a computer disk, compact disk, or some similar data storage and transfer device 3740 to use to transfer the data to the manufacturing facility. A shipping service (e.g. UPS, Federal Express, U.S. Postal Service) or courier service 3745 picks up the data storage transfer device 3740 and transports it from the studio 3701 to the manufacturing facility MF 3702.

The data storage and transfer device 3740 is taken into the manufacturing facility 3702 and loaded onto a controller computer CC26 3755. The controller computer CC26 3755 uses the data to control 3-dimensional imaging machine IM5 3760 over control link 3756 to replicate the 3-dimensional image on the data storage transfer device 3740. The 3-dimensional imaging machine IMS 3760 can be one of the previous described embodiments or some similar embodiment. The replicated object 3770 of the 3-dimensional image data file may be the final art object ordered by the consumer 3710. However, the object 3770 produced by the 3-dimensional imaging machine IMS 3760 may require further processing and finishing.

The object 3770 may require additional processing into the ordered art object. The object 3770 may need to be dipped or sprayed with a preservative or stiffening coating. The object 3770 may need other finishing steps such as polishing, glazing, or plating. The object 3770 may be a molding for a cast or used as a pattern for a casting mold (e.g. green sand or lost wax method) to produce a metal figure in bronze, aluminum, pewter, silver or some other metal compound. Before being delivered, the object 3770 may also be hand or spray-painted, either to add color or as a protective, preservative finish. After the art object 3770 is completed, a shipping service, 3780 (e.g. UPS, Federal Express, U.S. Postal Service, etc.) is utilized to deliver the art object 3770 to the consumer 3710.

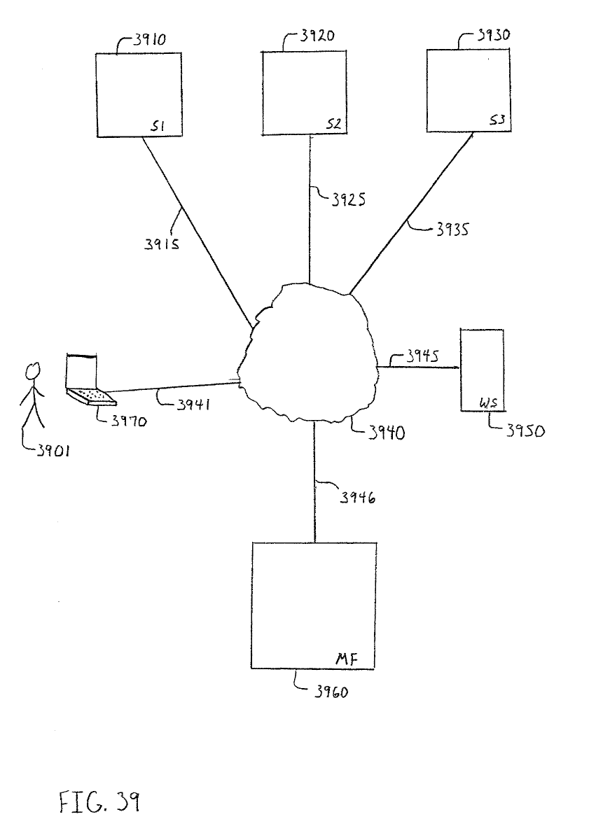

The present invention achieves economies of scale if several studios are used with a single remote manufacturing facility. A studio can also be set up where both capture of the image and production of the 3-dimensional art object occur in the same facility. Such an embodiment is shown in FIG. 38. There is a consumer 3810 and a studio 3801. There is an object 3820 to replicate. The studio 3801 contains a cash register or aother payment method 3815, a 3-dimensional image capturing system consisting of a camera set-up 3825 connected by a cable 3826 to an image-processing computer IC17 3830. The image-processing computer IC17 3830 is connected to a controller computer CC27 3855 by communication link 3840. The controller computer CC27 3855 is connected by control link 3856 to a 3-dimensional imaging machine IM6 3860. The controller computer CC27 3855 and the 3-dimensional imaging machine IM6 3860 are also located in the studio. The output of the 3-dimensional imaging machine IM6 3860 is art object 3870. There is a shipping service 3880 that picks up art object 3870 for delivery to consumer 3810.

The consumer 3810 enters the studio 3801. The consumer 3810 orders an art object and makes a payment at the cash register 3815. The consumer 3810 furnishes an object 3820 to reproduce as the ordered art object. A camera set up 3825 captures a 3-dimensional image of object 3820. This camera set up 3825 can be one of the previous described embodiments for capturing a 3-dimensional image or some other similar embodiment. The image data from camera set up 3825 is transmitted to an image-processing computer IC17 3830 by communication link 3826. The image is processed and finalized into a compatible file format for use by a 3-dimensional imaging machine IM6 3860. During the image-processing, the image is edited to the desired size and visual quality desired by the consumer. After the image is approved by the consumer and finalized, it is stored digitally on the computer or some other data storage medium. This stored data can be used to create a 3-dimensional photographic image and is available for potential reorder or additional adjustments. The file data is transmitted to the controller computer CC27 3855 by communication link 3840. The communication link 3840 may be a wire connection, or the data may be transferred using a data storage device.

Once the data to replicate is received by the controller computer CC27 3855, the controller computer CC27 3855 uses control link 3856 to control a 3-dimensional imaging machine IM6 3860 to replicate the 3-dimensional image file. The 3-dimensional imaging machine IM6 3860 can be one of the previous described embodiments for producing a 3-dimensional object or some other similar embodiment. The reproduced object 3870 may be the final art object ordered by the consumer. However, the object produced by the 3-dimensional imaging machine IM6 3860 may require further processing and finishing.

The object 3870 may require additional processing into the ordered art object. The object 3870 may need to be dipped or sprayed with a preservative or stiffening coating. The object 3870 may need to be dried at room temperature or in a low temperature high air-flow velocity oven to harden the material. The object 3870 may need other finishing steps such as polishing, glazing, or plating. The object 3870 may be a molding for a cast or used as a pattern for a casting mold (e.g. green sand or lost wax method) to produce a metal figure in bronze, aluminum, pewter, silver or some other metal or compound. Before being delivered, the object 3870 may also be hand or spray-painted, either to add color or as a protective, preservative finish. After the art object 3870 is completed, a shipping service 3880 (e.g. UPS, Federal Express, U.S. Postal Service, etc.) is utilized to deliver the art object to the consumer 3810.

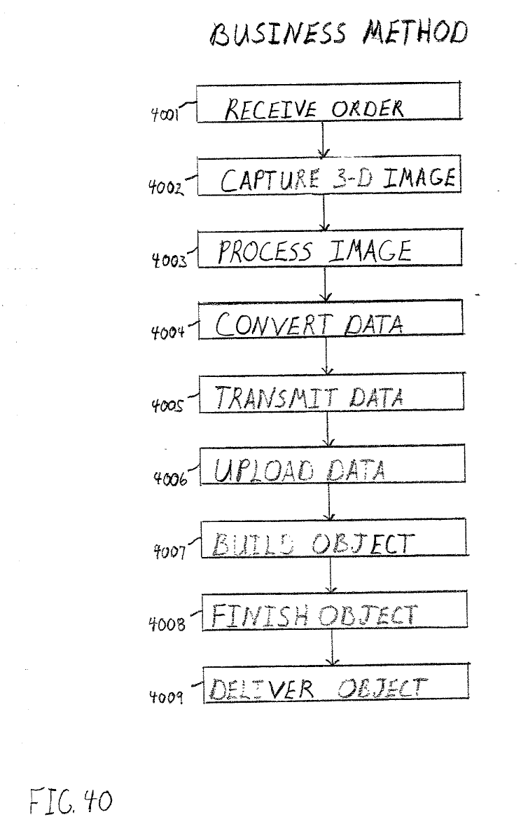

FIG. 39 is another embodiment incorporating an Internet website into the business method. FIG. 39 shows three studios—studio S1 3910, studio S2 3920, and studio S3 3930—each of which is set up like one of the previously described or a similar studio set up. Studio S1 3910 is connected to the Internet 3940 by communication link 3915. Studio S2 3920 is connected to Internet 3940 by communication link 3925. Studio₃ 3930 is connected to Internet 3940 by communication link 3935. A manufacturing facility MF 3960 is connected to the Internet 3940 by communication link 3946. A computer 3970 used by a consumer 3901 is connected to the Internet 3940 by communication link 3941. Finally, there is a website server WS 3950 connected to the Internet 3940 by communication link 3945.

3-dimensional images of objects are captured and processed at the studios. Studio S1 3910 transmits processed data sets to the Internet 3940 addressed to the manufacturing facility MF 3960 by communication link 3915. Studio S2 3920 transmits processed data sets to the Internet 3940 addressed to the manufacturing facility MF 3960 by communication link 3925. Studio S3 3935 transmits processed data sets to the Internet 3940 addressed to the manufacturing facility MF 3960. Based on the addresses in the data files, the Internet 3940 will route the data from studio S1 3910, studio S2 3920, and studio S3 3935 to manufacturing facility MF 3960 by communication link 3946.

Each of the studios 3910, 3920 and 3930 are also able to link to the website server WS using their respective communication links to the Internet 3940 and then to the website server WS 3950 over communication link 3945. A consumer 3901 can use a computer 3970 to access the website server WS 3950 using the Internet 3940. The computer 3970 can establish a communication link 3941 to the Internet 3940 and connect to the website server WS 3950 using communication link 3945 established by the Internet 3940.

The website hosted on the website server WS 3950 can be configured to allow a number of services accessible to a consumer 3901 over the Internet 3940. The consumer 3940 can then access the website using computer 3970 and utilize the offered services. The studios could also be linked to website server WS 3950 and would also be able to receive and transmit information and data.

This website or computer server 3950 can be configured to provide a number of services over the Internet 3940 using a consumer accessible interface on the website. One of the services is information dissemination. The website can provide information on the products available, how a 3-dimensional image is captured, and how the various products are produced. Pricing and payment methods may also be available. Studio location, business hours, and contact information is basic information that would also be available. The website could also provide appointment booking, so a consumer could access the website and set up an appointment at one of the linked studios. While three studios are shown, it is readily apparent that many studios may be linked to the website server WS 3950. Similarily, a number of manufacturing facilities may be connected to the website server WS 3950.

Generic items may also be offered for sale over the website. These items would provide tangible examples of the artwork that can be produced by the studios and 3-dimensional imaging machines and stimulate custom orders by the purchasing consumer. Reorders by previous customers using stored 3-dimensional data could also be done using the website. Orders might also be finalized over the website.

To finalize orders, the website server WS 3950 would be linked to the studio where the consumer 3901 had gone to have the 3-dimensional image data captured. If the consumer 3901 had gone to studio S1 3910, the website server WS 3950 would establish communication link 3915 to studio S1 3910 from the Internet 3940. The consumer 3901 would then be able to access the stored 3-dimensional image at studio S1 3910. The computer software on the website would permit the consumer 3901 to make various editing changes to the 3-dimensional image stored on an accessible computer or data file at studio S1 3910. Once the consumer 3901 finished making editing changes on the 3-dimensional images, he could finalize and store the images for conversion into a file format for use at the manufacturing facility MF 3960. Alternatively, the studio SI 3910 could transmit draft 3-dimensional images to the website server WS 3950, so a consumer 3901 can access the pictures and make editing changes and final approval. Another alternative would be to transmit draft data to the computer 3970 over the Internet 3940. The consumer 3901 could then access the website or website server WS 3950, edit the data using an interface on the website, and then transmit the data back to studio S1 3910 for conversion into a finalized format.

As another feature of the finalization process and ordering option that can be made available through the website 3950, a preview feature would allow a consumer 3901 to select a product and then generate a preview of the product using the image data. Using various options of the preview feature, the consumer could see how the image would appear as a variety of art objects (e.g. busts, bas-relief, statue, etc) in various finishes and materials (e.g. bronze, ceramic, unpainted plastic, painted plastic, ceramic, etc). The consumer 3901 could then use this feature to order one or several art objects derived from the same data set with different options.

Image data sets could also be stored on a centralized database on the website server WS 3950. Image data may also be stored on a computer at a studio or on some data storage medium at another location. There could be a storage device with multiple compact disks accessible through the website. If stored on the website server WS 3950 or a computer in studio S1 3910, studio S2 3920, or studio S3 3930, the consumer could access the stored image data and view the archived, stored image. New objects could be ordered using the website 3950 and the communication link to the studios via the Internet 3940. Or there could be some other centralized location with archived images on a computer or other data storage device that can be assessed using the website and new objects ordered.

The preferred and alternative embodiments of the business method of the invention shown are essentially summarized as steps in FIG. 40. The process begins at step 4001, which is to receive an order from a consumer at a studio. The consumer can learn about the process and studio location over a website, but at some point must go to a studio so that 3-dimensional image data can be captured. The consumer may also be able to make an appointment at a studio using a website. Fundamentally, at this step, the consumer locates and enters a studio, selects the type of art object he wishes to order, and, in general, pays for the order by cash or credit. However, it is possible for the customer to pay for the object at some other time such as upon delivery. Payment may also be on some monthly installment plan or by credit card.

Generic items may be ordered on a website, and reorders using archived data images may also be possible over a website. The next step 4002 is capture of a 3-dimensional image by a camera system and image-processing computer at a studio. At this stage, a 3-dimensional visual image of the object is captured by a camera system and integrated and processed by either the camera system itself or an image processing computer to generate a 3-dimensional data set of the object to be replicated. The next step 4003 is to process the image to the consumer specifications (e.g. life-size, half-size, cropped, remove undesirable visual aspects, etc.) on the image-processing computer. The data is manipulated and processed to reflect the desires of the consumer and conform with the ordered art object (e.g. bust, bas-relief, statue, etc.).

Another option is to have a website with access through the Internet, so that a consumer can access the data and make the changes. After consumer approval and finalizing, the next step 4004 is to convert the data into a 3-dimensional imaging machine compatible format. At this step, the image data is converted into data slices for reproduction as a 3-dimensional object on a 3-dimensional imaging machine.

Step 4005 is to transmit data to and receive data at a manufacturing facility. Generally, the converted data of step 4004 must be transmitted to a manufacturing facility. Transmission may be over a wire link such as the Internet, telephone, or dedicated communication link. However, data transfer could be by a data transfer device such as a computer disk or compact disk using the mail, a shipping service, or courier. For this step, the most likely embodiment will be for a manufacturing facility serving two or more studios. However, it is possible that the studio itself will be co-located with the necessary manufacturing equipment to produce the art object, or a studio may be co-located with the manufacturing facility. Once the data is received, the 3-dimensional data file object can be replicated.

Manufacturing the object begins at step 4006, which is to upload the transmitted data onto a controller computer. The controller computer controls a 3-dimensional imaging machine to replicate and build a three-dimensional image layer-by-layer. The next step 4007 is to build the 3-dimensional object on a 3-dimensional imaging machine. The machine can basically do this by adding or removing material based on the data slices of the 3-dimensional image data file. The controller computer controls a 3-dimensional imaging machine to successively build each layer of the object using the data received from the studio. The data layers may vary in thickness but can be smaller or larger than one-thousandth of an inch thick. These layers are bonded together to build the object.

The output of the 3-dimensional imaging machine may be the final art object. However, it is likely that some orders may require a finishing step 4008. Step 4008 is to finish the object into the final art object. The object that comes out of the 3-dimensional imaging machine may need further processing and finishing, such as polishing, glazing, plating, coating, casting, painting or some other process required to finish the built 3-dimensional image into the final art object. Casting or other services may also need to be contracted to other parties at a different location. This finishing step may be at the manufacturing facility MF or, as an alternative embodiment, delivered to the studio for finishing and delivery to the consumer.

The last step 4009 is to deliver the final art object to the consumer. Generally, a commercial shipping company such as UPS or Federal Express will pick up the art object at the manufacturing facility and transport it to the consumer. Alternative embodiments for delivering the art object to the consumer may include delivery to the studio for pick up by the consumer, delivery to the studio for courier service delivery to the consumer, delivery to a centralized pick up location where the consumer comes to pick it up, or delivery to a centralized delivery location for courier delivery of the object to the consumer. The object may also be a gift to deliver to another party as specified by the consumer.

While the invention is particularly shown and described with respect to preferred embodiments, it will be readily understood that minor changes in the details of the invention may be made without departing from the spirit of the invention. Having described the invention, we claim:

1. A method for producing an art object replica for a consumer comprising the steps of:
providing one or more studios, each said studio having one or more camera systems for capturing a 3-dimensional data set relating to an art object;
capturing said 3-dimensional data set at one of said studios; and
producing said art object replica using said captured 3-dimensional data set.

2. The method for producing a 3-dimensional art object replica for a consumer of claim 1 wherein the camera system comprises one or more 3-dimensional digital cameras.

3. The method for producing a 3-dimensional art object replica for a consumer of claim 1 wherein said art object replica is produced with a 3-dimensional imaging machine.

4. The method for producing a 3-dimensional art object replica for a consumer of claim 3 wherein the 3-dimensional imaging machine produces the art object replica by bonding horizontally-oriented layers.

5. The method for producing a 3-dimensional art object replica of claim 3 wherein the 3-dimensional imaging machine produces the art object replica by removing material from a block-like form.

6. The method for producing a 3-dimensional art object replica for a consumer of claim 1 further comprising the step of:
processing the captured 3-dimensional data set with a computer.

7. The method of producing a 3-dimensional art object replica for a consumer of claim 1 further comprising the step of:
providing a website on a website server accessible by a consumer.

8. The method of producing a 3-dimensional art object replica for a consumer of claim 7 wherein the website server is linked by a communication line to one or more of said studios.

9. The method of producing a 3-dimensional art object replica of claim 7 wherein the consumer can use the website to:
manipulate said 3-dimensional data sets; and
approve the production of said art object replica based upon a visual representation of said art object replica.

10. A process for producing an art object replica for a consumer comprising the steps of:
creating a 3-dimensional data set of an art object;
processing said 3-dimensional data set on a computer to create a processed 3-dimensional data set;
transferring said processed 3-dimensional data set to a controller computer; and,
producing an art object replica using the processed 3-dimensional data set.

11. The process for producing an art object replica for a consumer of claim 10 wherein the controller computer controls a 3-dimensional imaging machine used to produce said replica.

12. The process for producing an art object replica for a consumer of claim 11 wherein the 3-dimensional imaging machine produces said art object replica by bonding successive horizontally-oriented layers onto each other.

13. The process for producing an art object replica of claim 10 wherein said data set is created by one or more camera systems.

14. The process for producing an art object replica of claim 13 wherein one or more of said camera systems includes a laser.

15. The process for producing an art object replica of claim 10 further comprising the step of:
finishing said art object replica.

16. The process for producing an art object replica of claim 15 wherein finishing includes one or more of casting, plating, polishing, painting, coating, dipping, spraying, drying or glazing.

17. A process for providing a 3-dimensional art object replica to a consumer comprising the steps of:
creating a 3-dimensional data set for said art object to be replicated;
producing said 3-dimensional art object replica with a manufacturing machine based on the 3-dimensional data set; and
delivering the art object replica to the consumer after production by the manufacturing machine.

18. The process for providing a 3-dimensional art object replica to a consumer of claim 17 wherein the manufacturing machine produces the replica by successively bonding horizontally-oriented layers.

19. The process for providing a 3-dimensional art object replica to a consumer of claim 17 further comprising the step of:
finishing said art object replica by casting, plating, polishing, coating, or painting.

20. The process for providing a 3-dimensional art object replica to a consumer of claim 17 further comprising the step of:
providing a website accessible by said consumer for manipulation of the data set and approval of the 3-dimensional replica production.
